(19) United States
(12) Patent Application Publication
(10) Pub. No.: US 2024/0135148 A1
(43) Pub. Date: Apr. 25, 2024

(54) Semantic Representations of Mathematical Expressions in a Continuous Vector Space and Generation of Different but Mathematicallly Equivalent Expressions and Applications Thereof

(71) Applicant: The Board of Trustees of the University of Illinois, Urbana, IL (US)

(72) Inventors: Nickvash Kani, Champaign, IL (US); Neeraj Gangwar, Urbana, IL (US); Hongbo Zheng, Urbana, IL (US)

(21) Appl. No.: 18/479,242

(22) Filed: Oct. 2, 2023

Related U.S. Application Data
(60) Provisional application No. 63/413,277, filed on Oct. 5, 2022.

(51) Int. Cl. G06N 3/0455; G06N 3/044; G06N 3/0475; G06N 3/048

(52) U.S. Cl. CPC G06N 3/0455; G06N 3/044; G06N 3/0475; G06N 3/048

(57) ABSTRACT

Methods are provided herein for training and using models to generate semantically representative continuous vectors for input mathematical expressions. These methods result in models that output continuous vectors that are nearby in an embedding space for equations that are mathematically equivalent but differently written. Such continuous vectors can be used to facilitate indexing and searching of databases of mathematical equations, e.g., to facilitate semantically-aware searching of databases of mathematical texts for equations that are mathematically equivalent to, or mathematically similar to, input query expressions. These training methods include training an encoder together with a decoder to predict pairs of mathematically equivalent but different training expressions, with the output of the encoder being the continuous vector that represents the semantic mathematical content of the pair of training expressions. Also provided are methods for efficiently generating such pairs of mathematically equivalent but different training expressions.

### CROSS-REFERENCE TO RELATED APPLICATION

This application claims priority to U.S. Provisional Patent Application No. 63/413,277, filed on Oct. 5, 2022, the contents of which are hereby incorporated by reference in their entirety.

### BACKGROUND

Despite there being well-established search technologies for most other modes of data, there exist few or no major algorithms for processing mathematical content. One possible step toward processing such a new mode of data is to create embedding methods that can transform that information into a machine-readable format. Most mathematical equation modeling attempts have focused on establishing a homomorphism between an equation and surrounding mathematical text. While this approach can help find equations used in similar contexts, it overlooks the following key points: (1) there is a large amount of data in which equations occur without any context (consider textbooks that contain equations with minimal explanation), and (2) in scientific literature, the same equations may be used in a variety of disciplines with different contexts; encoding equations according to textual context hampers cross-disciplinary retrieval.

### SUMMARY

In a first aspect, a computer-implemented method is provided that includes: (i) obtaining a representation of an input mathematical expression; (ii) generating an initial e-graph representation of the mathematical expression; (iii) applying a set of mathematical rewrite rules to the initial e-graph a plurality of times to generate a saturated e-graph representation of the mathematical expression, wherein the saturated e-graph includes a root e-class that contains at least one e-node; (iv) generating a mathematical grammar based on the saturated e-graph by, for each e-class of the saturated e-graph, generating a respective set of one or more replacement expressions, wherein a replacement expression of a given e-class corresponds to a respective e-node of the given e-class; and (v) generating a plurality of different output mathematical expressions that are equivalent to the input mathematical expressions by, for strings representing each of the e-nodes in the root e-class, recursively applying the replacement expressions of the mathematical grammar to replace elements of the strings.

In a second aspect, a computer-implemented method is provided that includes: (i) obtaining a training dataset, wherein the training dataset contains a plurality of sets of mathematical expressions, wherein each set of mathematical expressions of the plurality of sets of mathematical expressions includes two or more mathematically equivalent but not identical mathematical expressions; and (ii) using the training dataset, training an encoder and a decoder to generate, as an output of the decoder, an output mathematical expression that is mathematically equivalent to but not identical to an input mathematical expression that is applied as an input to the encoder, wherein the encoder generates, as an output that is provided as an input to the decoder, a continuous vector that is representative of the input mathematical expression.

In a third aspect, a method is provided that includes: (i) obtaining a target mathematical expression; and (ii) applying the target mathematical expression as an input to an encoder trained as in the second aspect to generate a target continuous vector that is representative of the target mathematical expression.

In a fourth aspect, a computer-implemented method is provided that includes: (i) obtaining a target mathematical expression; and (ii) applying the target mathematical expression as an input to an encoder to generate a target continuous vector that is representative of the target mathematical expression, wherein the encoder comprises a mapping function and an encoder recurrent network, and wherein applying the target mathematical expression to the encoder to generate the target continuous vector includes: (a) parsing the target mathematical expression into an input ordered sequence of mathematical symbols; (b) applying each of the mathematical symbols of the input ordered sequence of mathematical symbols to the mapping function to generate respective embedding vectors, thereby generating an ordered sequence of embedding vectors that represent the input ordered sequence of mathematical symbols in an embedding space; and (c) executing the encoder recurrent network a plurality of iterations, wherein executing the encoder recurrent network a given first iteration of the plurality of iterations comprises generating a first output hidden vector in the embedding space based on (1) a second output hidden vector generated from a prior execution of the encoder recurrent network and (2) a first embedding vector of the ordered sequence of embedding vectors that corresponds to the first iteration, and wherein the continuous vector that is representative of the input mathematical expression is an output of the encoder recurrent network a final iteration of the plurality of iterations

In a fifth aspect, a non-transitory computer-readable medium is provided having stored thereon program instructions that, upon execution by a computing device, cause the computing device to perform the method of any of the above aspects.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The accompanying drawings are included to provide a further understanding of the system and methods of the disclosure and are incorporated in and constitute a part of this specification. The drawings illustrate one or more embodiment(s) of the disclosure, and together with the description serve to explain the principles and operation of the disclosure.

FIG. 1 illustrates aspects of an example method.

FIG. 2 illustrates aspects of an example model.

FIG. 3 illustrates experimental results.

FIG. 4A illustrates aspects of an example method.

FIG. 4B illustrates aspects of an example method.

FIG. 4C illustrates aspects of an example method.

FIG. 4D illustrates aspects of an example method.

FIG. 4E illustrates aspects of an example method.

FIG. 5 illustrates aspects of an example system.

FIG. 6 illustrates a flowchart of an example method.

FIG. 7 illustrates a flowchart of an example method.

FIG. 8 illustrates a flowchart of an example method.

FIG. 9 illustrates a flowchart of an example method.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

### I. Overview

Mathematical notation makes up a large portion of STEM literature, yet, finding semantic representations for formulae remains a challenging problem. Because mathematical notation is precise and its meaning changes significantly with small character shifts, the methods that work for natural text do not necessarily work well for mathematical expressions. Embodiments described herein provide an approach for representing mathematical expressions in a continuous vector space. An encoder of a sequence-to-sequence architecture or other variety of model architecture is trained on visually different but mathematically equivalent expressions to generate vector representations (embeddings). This approach is demonstrated to be better at capturing mathematical semantics than alternative approaches like autoencoders. Also provided are methods for generating and/or augmenting datasets of such equivalent expression pairs (or larger sets of equivalent expressions) for training the models described herein or for performing some other tasks (e.g., training some alternative models using such pairs or larger-numbered sets of mathematically equivalent but different mathematical expressions).

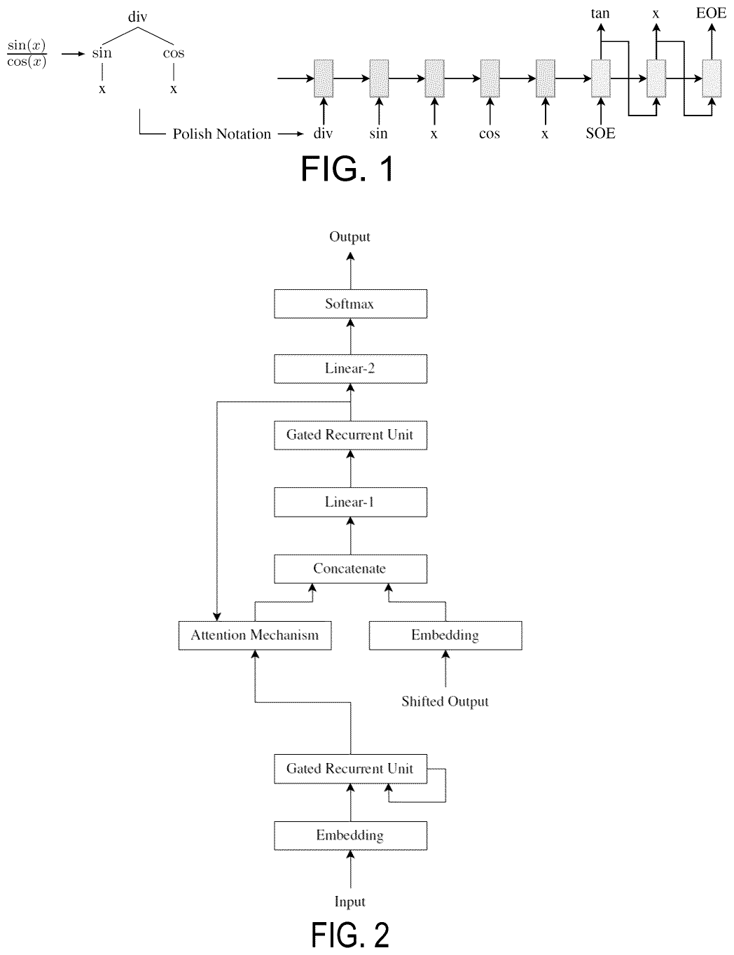

The embedding methods described herein learn to generate representations of mathematical expressions based on semantics. In some examples, a sequence-to-sequence model or other type of model is trained on equivalent expression pairs and the trained encoder is then used to generate vector representations. FIG. 1 shows aspects of an example of this approach that embeds expressions according to their mathematical semantics. Embeddings generated in this manner provide better clustering, retrieval, and analogy results. The efficacy of the approaches described herein is highlighted when compared to, e.g., an autoencoder. The embedding models described herein are also compared to two existing methods: EQNET and EQNET-L, further demonstrating the ability of the embodiments described herein to capture the semantic meaning of an expression.

Embeddings generated using the embodiments described herein can be used to improve information processing and retrieval tasks related to documents that contain equations or other mathematical contents.

Previous approaches generated embeddings for mathematical tokens and expressions using surrounding textual information, effectively establishing a homomorphism between mathematical and associated textual information. Such approaches suffer from at least two important limitations. Firstly, an embedding scheme should be able to process equations without surrounding text, such as in the case of pure math texts like the Digital Library of Mathematical Functions (DLMF). Relatedly, mathematically similar equations may be used in textual contexts that are sufficiently dissimilar (e.g., wholly different fields of study) that embeddings based on equation-associated text may not detect any similarity therebetween. Secondly, expressions that have equivalent semantic meaning may be written a multitude of ways (consider x⁻¹=1/x or sin(x) =cos(x−π/2)). The embedding method should understand that such expressions are mathematically equivalent and produce similar, or even identical, embeddings. EQNET and EQNET-L have been employed for finding semantic representations of simple symbolic expressions. However, these approaches were only trained such that the embeddings of equivalent expressions are likely to be grouped together. They fail to generate embeddings wherein semantically similar but non-equivalent expressions are clustered together.

Some of the embodiments described herein implement to process of embedding mathematical expressions as a sequence-to-sequence learning problem and apply an encoder-decoder framework, with the embedding taking the form of the continuous vector representation passed from the output of the encoder to the input of the decoder. word2vec-based approaches, which attempt to generate embeddings to represent the semantic content of English (or other language) text, assume that proximity to a word suggests similarity. For mathematical expressions, the embodiments herein train such that mathematical equivalence suggests similarity. A sequence-to-sequence model can be trained to generate expressions that are mathematically equivalent to input expressions; an encoder of such a model can thus learn to produce embeddings that map semantically equivalent expressions closer together. FIG. 1 shows aspects of an example of such an approach. To accomplish this, a machine learning model capable of learning equivalent expressions is trained, using a dataset of pairs (or larger sets) of equivalent expressions.

In encoder-decoder architectures, the encoder maps an input sequence to a vector. The decoder is conditioned on this vector to generate an output sequence. In the methods described herein, the encoder maps an expression to a vector that is referred to as the continuous vector representation of this expression. The decoder uses this representation to generate an output expression. The models described herein were trained in two decoder settings: (1) equivalent expression setting (EXPEMB-E), in which the decoder generates an expression that is mathematically equivalent to the input expression, and (2) autoencoder setting (EXPEMB-A), in which the decoder generates the input expression exactly.

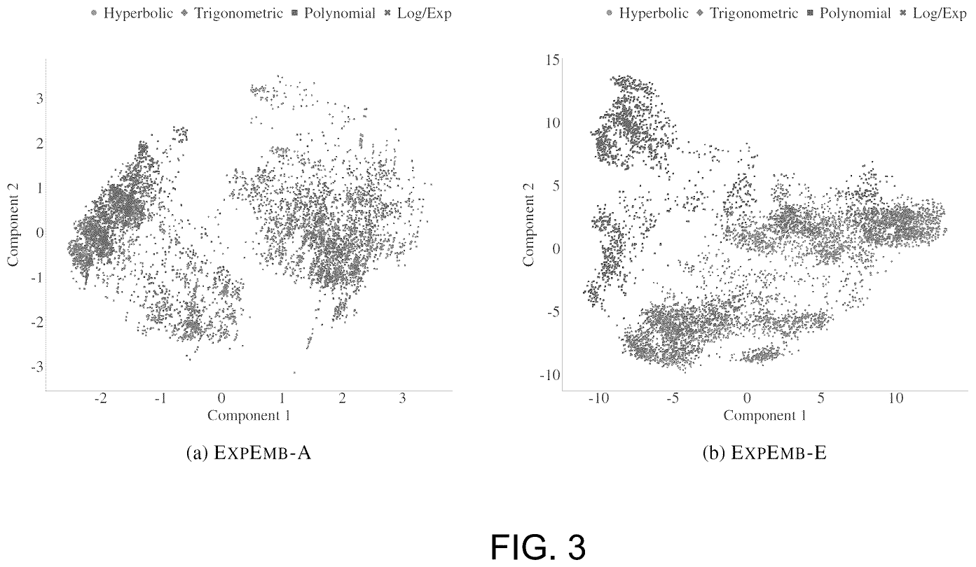

A variety of architectures are available for use as the encoder and/or decoder of a model as described herein, for example, Recurrent Neural Networks (RNN), Gated Recurrent Unit (GRU), Long Short-Term Memory (LSTM), Convolutional Networks (ConvNet), Transformers, etc. In an example, GRUs were used to model the encoder and decoder and an additive attention mechanism was used in the decoder. The final hidden state of the encoder depends on the entire input sequence and can be interpreted as the continuous vector representation or embedding of the input expression. An overview of such a model is shown in FIG. 2.

Mathematical expressions can be modeled as trees with nodes describing a variable or an operator. In some examples, a sequence-to-sequence model as described herein can be implemented using, e.g., the Polish (prefix) notation to convert such a tree into an ordered sequence of tokens. As shown by way of a non-limiting example in FIG. 1, this transforms the expression sin(x)/cos(x) into the sequence [div,sin,x,cos,x]. The encoder and decoder components are shown in green and orange, respectively. Given the example input expression, the model learns to generate tan(x). Tokens can be encoded as one-hot vectors and passed through an embedding layer before being fed to the encoder or decoder. The final hidden state of the encoder can be used as the continuous vector representation of the input expression. “SOE” and “EOE” are the start and end tokens, respectively, and “div” is the division operation

The teacher forcing algorithm can be applied during training and the beam search algorithm can be applied during validation and testing to achieve the results described herein. Because not all sequences produce valid expression trees, the beam search algorithm can be applied to find an output with minimum or otherwise reduced loss. As the training of a network as described herein progresses, the incidence of output expressions that produce invalid trees becomes more rare, showing that the network is capable of learning mathematical tree structures.

Training of such a model can be performed using a dataset of mathematically equivalent expression pairs. Such a dataset could include only pairs of mathematically equivalent expressions. Additionally or alternatively, such a dataset could include larger-number sets of equivalent expressions that can be sampled from to generate pairs of equivalent expressions for training a model as described herein (e.g., such a dataset could include a set {sin(x), -sin(-x), cos(pi/2-x), sin(pi-x)} from which pairs of expressions can be samples to train a model). Working from a known collection of simple mathematical expressions, SymPy was used to create an Equivalent Expressions Dataset that included ˜4.6 M pairs of equivalent expressions.

FIG. 2 depicts, by way of a non-limiting example, aspects of a model architecture described herein. An input expression (represented in, e.g., the Polish notation) is fed into the encoder (at the bottom of FIG. 2) as a sequence of tokens. The encoder processes the input and generates the embedding. The hidden states of the encoder are passed to the decoder to generate an output expression. The encoder and/or decoder could include models of a variety of different architectures, e.g., Transformers.

Valid mathematical expressions for training can be generated in a variety of ways. For example, expressions can be extracted from publicly available datasets and pre-processing performed thereon to remove parts of the input expressions that are superfluous. This process results in set of valid mathematical expressions. Additionally or alternatively, the equivalent expression generation methods described elsewhere herein can be employed to generate, from a set of mathematical expressions, a plurality of sets of equivalent mathematical expressions. From this group of expressions, SymPy was used to generate mathematically equivalent but visually different counterparts. For each pair of equivalent expressions x₁ and x₂, two training examples (x₁,x₂) and (x₂, x₁) were added to the training dataset. In this data generation process, expressions that resulted in NaN (Not a Number) when parsed using SymPy were excluded.

The training dataset used to generate the results depicted herein had 4,662,232 input-output pairs representing 2,744,809 unique expressions. Note that the number of equivalent expression pairs per unique expression is not straightforward to compute because some expressions result in more equivalent expressions than others. All expressions were univariate and included operators selected from the following list:

TABLE 1
Number of expressions containing a type of operator
in the Equivalent Expressions Dataset.

| Operator Type | # Expressions |
|---|---|
| Arithmetic | 1,423,972 |
| Trigonometric | 341,805 |
| Hyperbolic | 214,731 |
| Logarithmic/Exponential | 901,460 |

### Expressions Dataset

Arithmetic: +, −, x, /, abs, pow, sqrt
Trigonometric: sin, cos, tan, cot, sec, csc, sin−1, cos−1, tan−1
Hyperbolic: sinh, cosh, tanh, coth, sinh⁻¹, cosh⁻¹, tanh⁻¹
Logarithmic/Exponential: ln, exp

For embedding analysis, the results depicted herein only considered simple polynomial and transcendental mathematical expressions. Further, the input and output expressions were limited to have a maximum of five operators. Note that these limitations were applied for the purposes of illustration; in practice, the training methods herein could be applied to training datasets of expressions that include more than polynomial and transcendental mathematical expressions and/or expressions having more than five operators. Table 1 shows the number of expressions containing a particular type of operator. Note that one expression can contain multiple types of operators. The sequence length of the expressions in the training dataset was 16.18±4.29. The validation and test datasets contained 2,000 and 5,000 expressions with sequence lengths of 15.03±4.31 and 16.20±4.13, respectively.

Two models were evaluated experimentally:

EXPEMB-E refers to the model trained on disparate but mathematically equivalent expression pairs.

EXPEMB-A refers to an autoencoder that is trained to generate the same expression as the input.

The autoencoder approach serves as a benchmark, demonstrating that EXPEMB-E yields representations that better describe semantics and that are superior for clustering, retrieval, and analogy tasks. The model shown in FIG. 2 was evaluated in the experiments described below.

EXPEMB-E can learn to generate equivalent expressions for a given input. To evaluate if two expressions x₁ and x₂ are mathematically equivalent, their difference x₁−x₂ was simplified using SymPy compare to 0. In this setting, if the model produced an expression that was the same as the input, it was not counted as a model success. There were instances in which SymPy took significant time to simplify an expression and eventually failed with out-of-memory errors. To handle these cases, a threshold was applied at execution time. If the simplification operation took more time than the threshold, it was counted as a model failure. EXPEMB-A was also evaluated to verify whether it learned to generate the input exactly. This served as an contrastive benchmark for evaluating EXPEMB-E and was useful in quantifying how well a sequence-to-sequence model as described herein was able to represent the underlying mathematical structure of the training data. During the evaluation, the beam search algorithm was used to generate output expressions. Since such outputs can be verified programmatically, all the outputs in the beam were considered. If any of the outputs were correct, it was counted as a model success.

EXPEMB-A was trained with H=128 and EXPEMB-E was trained with H=1024 for these experiments where H is the model dimension. The accuracy of these models is shown in Table 2. Note that EXPEMB-A was able to encode and generate the input expression and achieved a near-perfect accuracy with H=128 and greedy decoding (beam size=1). The results for EXPEMB-E demonstrate that generating equivalent expressions is a significantly harder task. For this setting, the greedy decoding did not perform well. An improvement of 35% was observed for a beam size of 50. However, a jump in the number of invalid expressions being assigned high log probabilities was also observed with this beam size. This experiment demonstrated that both EXPEMB-A and EXPEMB-E are capable of learning the mathematical structure in the training data, and that EXPEMB-E can learn to generate expressions that are mathematically equivalent to the input expression. While EXPEMB-E achieves a lower accuracy than EXPEMB-A, the former exhibits some interesting properties and is more useful for retrieval tasks.

The usefulness of the representations generated by the EXPEMB-E model was also evaluated. Unlike the natural language textual embedding problem, there do not currently exist standard tests to quantitatively measure the embedding performance of methods built to embed mathematical expressions. These experiments showed some interesting properties of the representations generated by the EXPEMB-A and EXPEMB-E models and demonstrated the efficacy of the approach described herein.

TABLE 2
Accuracy of EXPEMB-A and EXPEMB-E on the datasets with
expressions containing a maximum of 5 operators (sequence
length 16.18 ± 4.29 for the training dataset).

| Beam Size | EXPEMB-A | EXPEMB-E |
|---|---|---|
| 1 | 0.9994 | 0.5188 |
| 10 | 1.0000 | 0.7736 |
| 50 | 1.0000 | 0.8666 |

To evaluate whether similar expressions were clustered in the embedding vector space, the representations generated by the EXPEMB-E and EXPEMB-A models were plotted and compared. For this experiment, 8,000 simple expressions were used that belong to one of the following categories: hyperbolic, trigonometric, polynomial, and logarithmic/exponential. Each expression is either polynomial or contains hyperbolic, trigonometric, or logarithmic/exponential operators. Below are a few examples of expressions belonging to each of these classes:
Polynomial: x²+2x+5, 2x+2
Trigonometric: sin(x)tan(x), cos⁵(4x)
Hyperbolic: cosh(x−4), sinh(xcos(2))
Log/Exp: e^{-2x-4}, log(x+3)³

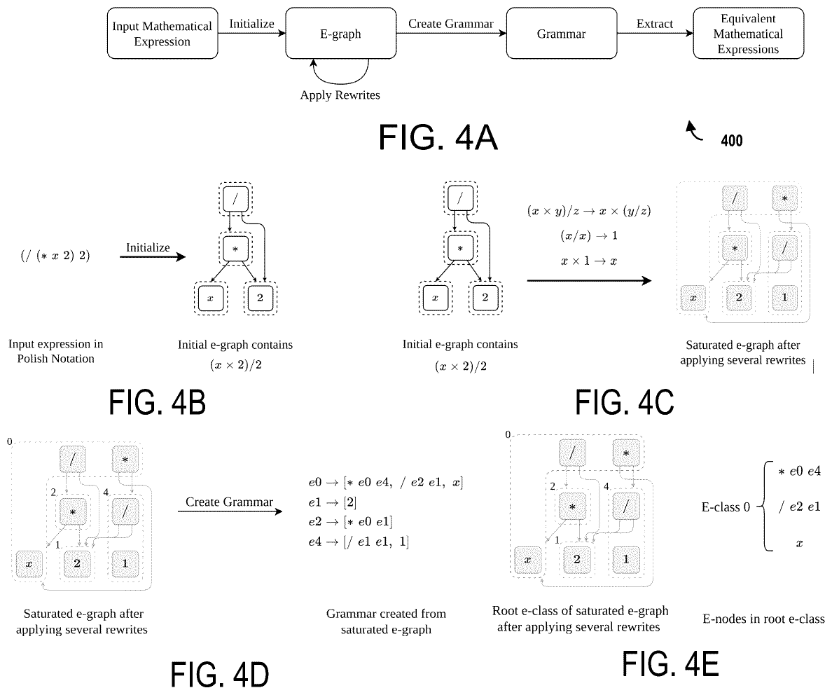

To qualitatively illustrate the ability of these models to group semantically similar expressions together in the space of the embedding vector, Principal Component Analysis (PCA) was used for dimensionality reduction from 128 (EXPEMB-A) and 1024 (EXPEMB-E) to 2. FIG. 3 shows the plots for EXPEMB-A and EXPEMB-E. These plots illustrate that the clusters in the EXPEMB-E plot are more distinguishable compared to the EXPEMB-A plot and that EXPEMB-E does a better job at grouping similar expressions together. For EXPEMB-E, there is an overlap between expressions belonging to hyperbolic and logarithmic/exponential classes. This is expected because hyperbolic operators can be written in terms of the exponential operator. EXPEMB-A generated results focusing on the structure of the expressions and grouped together expressions that followed the same overall structure. For example, representations generated by EXPEMB-A for x²−2x, log(2x+5), tanh(3x+4), tanh⁻(3x+4), x² (x+5), 2x−5, log(8−4x), 4x+8, and cos(5x+15) were grouped together. On the other hand, representations generated by EXPEMB-E captured semantics in addition to the overall structure.

To evaluate the applicability of the embeddings for the information retrieval task, distance analysis was performed on a sample of 10,000 expressions. The similarity between two expressions was defined as the inverse of the cosine distance between their vector representations. The five closest expressions to a given query were identified for evaluation. Table 3 shows the results of this experiment. The closest expressions computed using EXPEMB-E embeddings were qualitatively more similar to the query in terms of overall structure and operators. On the other hand, EXPEMB-A apparently focused on a specific part of the query and found other expressions that shared that particular feature. For example, the first query in Table 3 consists of polynomial and trigonometric expressions. The closest expressions computed using EXPEMB-E follow the same structure, whereas the expressions computed using EXPEMB-A seem to focus on the polynomial part of the query. This behavior is also apparent in the second example. This ability of EXPEMB-E to group together similar expressions with respect to overall structure can prove useful in information retrieval problems where the aim is to find similar expressions to a given query.

TABLE 3
Expressions closest to a given query computed using representations
generated by EXPEMB-A and EXPEMB-E models. EXPEMB-E does a better job at learning the
semantics and overall structure of the expressions than EXPEMB-A.

| Query | EXPEMB-A | EXPEMB-E |
|---|---|---|
| 21x − 3sin (x) | 1. 11x − 2e^{x} | 1. 52x + 4 sin (x) |
| | 2. 2x + acosh (11x) | 2. 75x + 25 sin (x) |
| | 3. −x + e^{11x} | 3. 257x + 256 cos (x) |
| | 4. xe^{-21x} | 4. 7x − 7 sin (x) |
| | 5. sin (asinh (x + 21)) | 5. 7x − tan (4) |
| $\frac{3 x}{4} + cos ( x ) + 9$ | 1. $2 x ( \frac{5 x}{4} + cos ( x ) )$ | 1. $\frac{x}{25} + cos ( x ) + 2$ |
| | 2. $( \frac{x}{4} - 1 ) cos ( x )$ | 2. $3 x + cos ( x ) + \frac{5}{4}$ |
| | 3. 24x + cos (x) + 3 | 3. −x + cos (x) + 7 |
| | 4. $cos ( x ) = 3 tan ( \frac{x}{3} )$ | 4. 6x + cos (x) + 17 |
| | 5. x (2x + 7) cos (x) | 5. 3x + cos (x) + 12 |

Word representations generated by methods like word2vec and GloVe exhibit an interesting property in that simple algebraic operations on the representations can be used to solve analogies of the form “x₁ is to y₁ as x₂ is to y₂”. To investigate whether representations generated by the model described herein exhibit similar properties, simple algebraic operations were performed on the representations generated by the models described herein. For a given triplet of expressions x₁, y₁, and y₂, z=emb(x₁)−emb(y₁)+emb(y₂) was computed and the expression with representation closest to z in terms of cosine similarity was found. Here, ‘emb’ represents a function that returns the vector representation for an input expression. For this experiment, the entire training set was used to ensure that all the expressions required for an analogy were present in this set.

Table 4 shows the results for EXPEMB-A and EXPEMB-E. EXPEMB-E works for the first four examples and returns the expected expressions. This demonstrates a degree of semantic learning. In contrast, EXPEMB-A performs poorly on this task, demonstrating the value of the EXPEMB-E approach. There are cases for which neither EXPEMB-E nor EXPEMB-A generates the expected output, but even in these cases, the EXPEMB-A results are poorer when compared to EXPEMB-E.

TABLE 4
Examples of embedding algebra on the representations generated by
EXPEMB-A and EXPEMB-E. EXPEMB-E gets the first four analogies correct and generates
reasonably close outputs for the remaining compared to EXPEMB-A

| x₁ | y₁ | y₂ | x₂ (expected) | EXPEMB-A | EXPEMB-E |
|---|---|---|---|---|---|
| cos(x) | sin(x) | csc(x) | sec(x) | cosh⁻¹(x) | sec(x) |
| sin(x) | cos(x) | cosh(x) | sinh(x) | ex | sinh(x) |
| sin(x) | csc(x) | sec(x) | cos(x) | cos(x) | cos(x) |
| x² − 1 | x + 1 | x + 2 | x² − 4 | $\frac{x}{log {( x )}^{2}}$ | x² − 4 |
| x² − 1 | x + 1 | 2x + 2 | 4x² − 4 | $log ( {x}^{\frac{3}{22}} )$ | x² − 4 |
| sin(x) | sinh(x) | cosh(x) | cos(x) | πx | cosh(sinh(x)) |
| x² | x | sin(x) | sin²(x) | 10x² | x² sin(x) |

Prior works have examined if machine learning models can generate semantic representations for equivalent expressions. This property has previously been measured as the proportion of k nearest neighbors of each test expression that belong to the same class. For a test expression q belonging to a class c, the score is defined as

$${score}_{k} ( q ) = \frac{\vert {ℕ}_{k} ( q ) ⋂ c \vert}{min ( k , \vert c \vert )} \qquad ( 1 )$$

where Nk(q) represents k nearest neighbors of q based on cosine similarity.

The datasets published by Allamanis et al. (2017) were applied for this evaluation. These datasets contain equivalent expressions from the Boolean (BOOL) and polynomial (POLY) domains. In these datasets, a class is defined by an expression, and all the equivalent expressions belong to the same class. The datasets are split into training, validation, and test sets and contain two test sets: (1) SEENEQCLASS containing classes that are present in the training set, and (2) UNSEENEQCLASS containing classes that are not present in the training set. To transform the training set into the input-output format used by EXPEMB-E, all possible pairs for the expressions belonging to the same class were generated. To limit the size of the generated training set, a maximum of 100,000 random pairs were selected from each class. For EXPEMB-A, all the expressions present in the training set were used.

TABLE 5
score₅(%) for UNSEENEQCLASS of the SEMVEC datasets.
The scores for EQNET and EQNET-L are from their
published work (Allamanis et al., 2017; Liu, 2022).
For EXPEMB-A and EXPEMB-E, the best scores and the
corresponding model dimensions H are shown.

| | EQNET | EQNET-L | EXPEMB-A | | EXPEMB-E | |
|---|---|---|---|---|---|---|
| | score₅ | score₅ | score₅ | | score₅ | |
| Dataset | (%) | (%) | (%) | H | (%) | H |
| SIMPBOOL8 | 97.4 | — | 27.1 | 1024 | 99.5 | 1024 |
| SIMPBOOL10 | 99.1 | — | 16.3 | 128 | 80.9 | 256 |
| BOOL5 | 65.8 | 73.7 | 25.1 | 256 | 57.1 | 64 |
| BOOL8 | 58.1 | — | 22.5 | 512 | 100.0 | 1024 |
| BOOL10 | 71.4 | — | 4.6 | 1024 | 77.5 | 1024 |
| SIMPBOOLL5 | 85.0 | 72.1 | 28.5 | 64 | 79.7 | 128 |
| BOOLL5 | 75.2 | — | 15.5 | 1024 | 70.4 | 256 |
| SIMPPOLY5 | 65.6 | 56.3 | 12.5 | 256 | 31.2 | 1024 |
| SIMPPOLY8 | 98.9 | 98.0 | 31.3 | 64 | 97.2 | 256 |
| SIMPPOLY10 | 99.3 | — | 28.7 | 1024 | 100.0 | 256 |
| ONEV-POLY10 | 81.3 | 80.0 | 55.8 | 1024 | 75.5 | 1024 |
| ONEV-POLY13 | 90.4 | — | 28.2 | 128 | 99.7 | 512 |
| POLY5 | 55.3 | — | 22.0 | 1024 | 48.1 | 128 |
| POLY8 | 86.2 | 87.1 | 19.8 | 512 | 76.6 | 512 |

Both EXPEMB-A and EXPEMB-E were trained with H=64, 128, 256, 512, and 1024. To evaluating the models described herein, the UNSEENEQCLASS test set was used. Table 5 shows the scores achieved by this approach. This table shows the best scores and corresponding model dimensions H for EXPEMB-A and EXPEMB-E. Observe that (1) the representations learned by EXPEMB-E capture semantics and not just the syntactic structure, and (2) EXPEMB-A does not perform as well as EXPEMB-E. Further observe that EXPEMB-E achieves a similar performance as EQNET and EQNET-L on most of the datasets. Also, EXPEMB-E performs better than EQNET and EQNET-L on the datasets with sufficiently large training sets. Though the representation sizes (synonymous with model dimension H in the approach described herein) were higher for EXPEMB-E than the one used in EQNET and EQNET-L, the encoder evaluated herein is more simple compared to both of these alternative approaches. The encoder evaluated herein consists of a GRU layer, whereas EQNET and EQNET-L use TREENN-based encoders. Additionally, the training for EQNET and EQNET-L explicitly pushes the representations of expressions belonging to the same class closer, whereas the approach described herein leaves it to the model to infer from the dataset.

Systems and methods described herein are capable of representing mathematical expressions in a continuous vector space. A sequence-to-sequence model can be trained to generate expressions that are mathematically equivalent to the input, and the encoder of such a model can then be used to generate vector representations of mathematical expressions. Quantitative and qualitative experiments and demonstrated that these representations encode the semantics of such expressions and not merely syntactic structure. These experiments also showed that these representations perform better at grouping similar expressions together and at performing analogy tasks when compared to the representations generated by an autoencoder.

The approach described herein was also applied to a dataset of longer expressions. The sequence length for this dataset was 31.95±30.27 for the training set and 36.40±40.49 for the test set. EXPEMB-A with H=128 performed well for this dataset. However, EXPEMB-E did not perform as well for this dataset even with H=2048. Table 7 shows the accuracy of the approach described herein for both of these settings. Simply increasing the model dimension from 1024 to 2048 did not result in the desired gain. The models and other embodiments herein should generalize for longer expressions, given a model that learns to generate equivalent expressions.

An evaluation of compositionality on the SEMVEC datasets was also performed. For this evaluation, a model as described herein was trained on a simpler dataset and evaluated on a complex dataset. For example, a model trained on BOOLS was evaluated on BOOL10. UNSEENEQCLASS was used for the evaluation. The results of this experiment are shown in Table 6. The model as described herein did not perform as well as EQNET on this task, even for the datasets for which such a model achieved a better scorek(q).

TABLE 6
Compositionality test of EXPEMB-E. score₅(%) achieved
on UNSEENEQCLASS of a dataset represented by “To”
on a model trained on the dataset represented by “From”.

| From → To | EXPEMB-E |
|---|---|
| BOOL5 → BOOL10 | 3.7 |
| BOOL5 → BOOL8 | 16.4 |
| BOOLL5 → BOOL8 | 32.5 |
| ONEV-POLY10 → ONEV-POLY13 | 60.0 |
| POLY5 → POLY8 | 28.1 |
| POLY5 → SIMPPOLY10 | 39.5 |
| POLY8 → ONEV-POLY13 | 52.3 |
| POLY8 → SIMPPOLY10 | 95.6 |
| POLY8 → SIMPPOLY8 | 97.8 |
| SIMPPOLY5 → SIMPPOLY10 | 34.6 |
| SIMPPOLY8 → SIMPPOLY10 | 93.4 |

TABLE 7
Accuracy of EXPEMB-A and EXPEMB-E on the datasets
with longer expressions (sequence length 31.95 ±
30.27 for the training dataset).

| Beam Size | EXPEMB-A | EXPEMB-E |
|---|---|---|
| 1 | 0.9969 | 0.4377 |
| 10 | 0.9993 | 0.6977 |
| 50 | 0.9995 | 0.7709 |

A model as described herein can be implemented in a variety of ways. For example, let x=(x₁,x₂ . . . x_{N}) and y=(y₁,y₂ . . . x_{M}) represent an input and output pair of mathematical expressions. Each xᵢ is first mapped to a static vector eᵢ (e.g., by the “Embedding” step depicted in FIG. 2). This sequence of vectors is passed to a GRU which produces a hidden state hᵢ for each time step 1≤i≤N according to the following equations (which are collectively referred to herein at equation (2)):

rᵢ=σ(Wᵣeᵢ+Uᵣhᵢ₋₁)

zᵢ=σ(W_{z}eᵢ+U_{z}hᵢ₋₁)

h_{ĩ}=tanh(Weᵢ+U(rᵢ⊙hᵢ₋₁))

hᵢ=(1−zᵢ)⊙hᵢ₋₁+zᵢ⊙h_{ĩ}

where rᵢ, zᵢ, and h_{ĩ}are the reset gate, update gate, and proposed state at time step i, respectively. σ and ⊙ denote the sigmoid function and elementwise product, respectively. The final hidden state, h_{N}, depends on the entire input sequence and can be interpreted as the continuous vector representation of the input expression. The decoder generates an output expression conditioned on the encoder hidden states hi for 1≤i≤N. It first computes a context vector ct at time step t according to the following equations:

$${a}_{i , t} = {v}_{a}^{T} tanh ( {W}_{a} {s}_{t - 1} + {U}_{a} {h}_{i} )$$

$${c}_{t} = {\sum }_{i = 1}^{N} \frac{exp ( {a}_{i , t} )}{{\sum }_{j = 1}^{N} exp ( {a}_{j , t} )} {h}_{i}$$

where oₜ represents the decoder hidden state at time step t. The context vector cₜ is combined with the static vector representation of the output token predicted at the previous time step as:

dₜ=W_{c}[cₜ,oₜ₋₁] (4)

where of represents the static vector representation of yₜ, the output token at time step t. dₜ follows (2) to generate the decoder hidden state sₜ. The probability of the output token yt is defined as:

P(yₜ|y₁ . . . tₜ₋₁, x)=softmax(Wₒsₜ) (5)

For each time step, the decoder produces a probability distribution of yₜ. The probability of the output sequence y is defined as:

P(y|x)=Πₜ₌₁^{M}P(yt|y1 . . . yt−1, x) (6)

At inference time, max pooling could be applied to the hidden state of a final layer of the encoder (e.g., a final layer of a Transformer-type model) in order to generate the continuous vector representation of an input expression. Alternatively, average pooling of the hidden states of the final encoder layer could be used, or the hidden states of the final encoder layer corresponding to the first and last tokens of an input sequence could be used to generate the continuous vector representation.

The log-likelihood of the output sequence was maximized or otherwise increased via training. For an example pair (x,y), the loss is defined as:

P(y|x)=−Σₜ₌₁^{M}logP(yt|y1 . . . yt−1, x) (7)

Table 10 shows the dimensions of different layers in the architecture shown in FIG. 2.

SymPy was used to generate mathematically equivalent expressions for a given expression. The operations shown in Table 9 were applied to a given expression to get mathematically equivalent expressions. The examples shown in the table are intended as non-limiting examples to illustrate the functionality of each operation. The rewrite function was applied to expressions containing trigonometric or hyperbolic operations. Specifically, this function was used to rewrite an expression containing trigonometric (or hyperbolic) operators in terms of other trigonometric (or hyperbolic) operators.

TABLE 9
List of SymPy functions with examples that were
used to generate equivalent expressions

| Function | Input(s) | Output |
|---|---|---|
| simplify | sin(x)² + cos(x)² | 1 |
| expand | (x + 1)² | x² + 2x + 1 |
| factor | x² + 5x + 6 | (x + 2)(x + 3) |
| cancel | (x³ + 2x)/x | x² + 2 |
| trigsimp | sin(x)cot(x) | cos(x) |
| expand_log | ln(x²) | 2ln(x) |
| logcombine | ln(x) + ln(2) | ln(2x) |
| rewrite | sin(x), cos | cos(x − π/2) |

TABLE 10
Input and output dimensions of the layers in the model architecture
depicted in FIG. 2 (B: batch size, S: input sequence length,
T: output sequence length, V: vocabulary size, H: model dimension).
In some examples, a Transformer architecture with 6 encoder
layers, 6 decoder layers, 8 attention heads, and ReLU activation
was used to achieve the results described herein.

| | Layer | Input | Output |
|---|---|---|---|
| Encoder | Embedding | B × S | B × S × H |
| | GRU | B × S × H, B × H | B × S × H |
| Decoder | Embedding | B × T | B × T × H |
| | Attention | B × S × H, B × T × H | B × T × H |
| | Linear-1 | B × T × 2H | B × T × H |
| | GRU | B × T × H, B × H | B × T × H |
| | Linear-2 | B × T × H | B × T × V |
| | Softmax | B × T × V | B × T × V |

Table 8 shows the number of examples in the training set of the SEMVEC datasets. The validation and test sets were used in their original form. To generate scoreₖ(q) for the models described herein, the source code provided by Allamanis et al. (2017) was used.

TABLE 8
Number of training examples in the transformed
training sets of the SEMVEC datasets.

| Dataset | EXPEMB-A | EXPEMB-E |
|---|---|---|
| SIMPBOOL8 | 21,604 | 4,440,450 |
| SIMPBOOL10 | 13,081 | 1,448,804 |
| BOOL5 | 712 | 17,934 |
| BOOL8 | 146,488 | 16,143,072 |
| BOOL10 | 25,560 | 3,041,640 |
| SIMPBOOLL5 | 6,009 | 66,876 |
| BOOLL5 | 23,219 | 552,642 |
| SIMPPOLY5 | 156 | 882 |
| SIMPPOLY8 | 1,934 | 113,660 |
| SIMPPOLY10 | 31,143 | 6,731,858 |
| ONEV-POLY10 | 767 | 25,590 |
| ONEV-POLY13 | 60,128 | 9,958,406 |
| POLY5 | 352 | 1,350 |
| POLY8 | 6,785 | 257,190 |

Table 11 shows the results of the approach described herein when applied to the SEMVEC datasets. It can be seen that EXPEMB-A performs worse than EXPEMB-E for all values of H. This may be related to the autoencoder training applying each expression in isolation and not utilizing the fact that each expression belongs to a particular class. Hence, the representations learned by this model may not capture the semantics of mathematical expressions and may only capture the structure.

TABLE 11
score₅(%) achieved by the models described herein
on UNSEENEQCLASS of the SEMVEC datasets.

| | EXPEMB-A | | | | | EXPEMB-E | | | | |
|---|---|---|---|---|---|---|---|---|---|---|
| Dataset | H = 64 | 128 | 256 | 512 | 1024 | 64 | 128 | 256 | 512 | 1024 |
| SIMPBOOL8 | 22.7 | 23.4 | 20.7 | 26.6 | 27.1 | 93.2 | 95.5 | 97.2 | 98.8 | 99.5 |
| SIMPBOOL10 | 10.0 | 16.3 | 10.0 | 9.3 | 11.7 | 59.4 | 62.1 | 80.9 | 75.7 | 78.2 |
| BOOL5 | 16.3 | 9.1 | 25.1 | 21.3 | 21.3 | 57.1 | 49.5 | 51.9 | 52.3 | 56.9 |
| BOOL8 | 11.8 | 10.6 | 15.0 | 22.5 | 19.6 | 98.4 | 99.9 | 100.0 | 100.0 | 100.0 |
| BOOL10 | 3.0 | 4.0 | 3.5 | 4.3 | 4.6 | 29.5 | 39.1 | 47.8 | 71.5 | 77.5 |
| SIMPBOOLL5 | 28.5 | 16.8 | 16.9 | 23.3 | 22.4 | 46.1 | 79.7 | 63.2 | 76.3 | 68.1 |
| BOOLL5 | 10.9 | 15.2 | 3.8 | 15.1 | 15.5 | 46.4 | 46.8 | 70.4 | 52.0 | 50.7 |
| SIMPPOLY5 | 8.3 | 4.2 | 12.5 | 4.2 | 4.2 | 14.6 | 15.6 | 27.1 | 25.0 | 31.2 |
| SIMPPOLY8 | 31.3 | 28.3 | 26.7 | 28.6 | 29.8 | 82.7 | 95.4 | 97.2 | 96.7 | 91.8 |
| SIMPPOLY10 | 24.6 | 25.5 | 25.1 | 26.0 | 28.7 | 99.8 | 99.9 | 100.0 | 99.9 | 100.0 |
| ONEV-POLY10 | 43.8 | 36.6 | 44.3 | 44.8 | 55.8 | 48.5 | 58.2 | 70.9 | 74.6 | 75.5 |
| ONEV-POLY13 | 20.9 | 28.2 | 25.7 | 26.2 | 26.6 | 94.0 | 99.1 | 99.5 | 99.7 | 99.7 |
| POLY5 | 7.8 | 18.8 | 17.9 | 20.5 | 22.0 | 28.9 | 48.1 | 41.9 | 36.8 | 30.6 |
| POLY8 | 8.7 | 18.3 | 18.7 | 19.8 | 18.8 | 41.6 | 64.5 | 69.3 | 76.6 | 76.3 |

Table 12 shows more example results relating to the distance analysis described above.

TABLE 12
Expressions closest to a given query computed using representations
generated by EXPEMB-A and EXPEMB-E.

| Query | EXPEMB-A | EXPEMB-E |
|---|---|---|
| x² − 8 sin (x) | 1. e (−x + sin (x) | 1. 20x² + 20 sin (x) |
| | 2. (4x + 36) cos (x) | 2. −2x² + 3sin (x) |
| | 3. x + \sqrt{7} cos (x) | 3. 9x + 12 sin (x) |
| | 4. −6x + 6 sin (x) | 4. ${x}^{2} + \frac{sin ( x )}{20}$ |
| | 5. −8x + 9 sin (x) | 5. 80x² + 160 sin (x) |
| cos (x + 1) + ½ | 1. 32 tan (x + 1) | 1. $\frac{sin ( x + 1 )}{2} + \frac{3}{2}$ |
| | 2. 6 cos (x + 1) | 2. 4x + cos (x + 1) + 3 |
| | 3. tan (x + 1) + 125 | 3. 6 cos (x + 1) |
| | 4. sinh (x + 1) + 6 | 4. $\frac{4 x cos ( x + 1 )}{5}$ |
| | 5. \sqrt{x + 1} − 3 | 5. cos (x + 4) + acos (5) |
| x (x cos (5) + asinh (x)) | 1. x + (x + asinh (5) asinh (x) | 1. x (−x cos (x) + x + acos (x)) |
| | 2. x (x + e^{asinh (x) + 5}) | 2. x (x + cos (2)) + asin (x) |
| | 3. \sqrt{x + tan (5)} + asinh (x) | 3. x² cos (x) + x + asin (x) + 2 |
| | 4. x sin (5) + x + log (x) | 4. x sin (1) + 3x + acosh (x) |
| | 5. (\sqrt{2}x + 3) sin (x) | 5. x (x asinh (3) + cos (x)) |
| 2x² (x + acos (2x) + 5) | 1. 4x² (\sqrt{x} + 2x + 2) | 1. 2x (6x + atanh (2x) + 3) |
| | 2. 2x − sin (asinh (x)) + 5 | 2. (x + 3) (x + asin (2x) + 1) |
| | 3. 2x + cos (x) + tan (2x) + 3 | 3. x² (asinh (2x) + 2) |
| | 4. x asin (2x) + 2x + 3 | 4. x (2x + atanh (2x) − 1) |
| | 5. $\frac{\sqrt{x} + 2 x - 5}{{x}^{4}}$ | 5. x (x + sinh (2x) + 4) + x |

For training the models described herein, expressions with a maximum of 512 tokens were used. The AdamW optimizer was used to train the models as described herein in order to obtain the results provided herein; however, other optimizers or other particulars of model training could be applied. For the Equivalent Expressions Dataset, a learning rate of 10⁻⁴ and a batch size of 64 were used. The same learning rate and batch size were used for the majority of the SEMVEC datasets, barring the ones mentioned in Table 13. For the datasets with longer equivalent expressions, a batch size of 32 with a learning rate of 10⁻⁴ was used.

TABLE 13
Datasets with hyperparameters for which the learning rate and
batch sizes are different than 10⁻⁴ and 64 respectively.

| | Decoder | | Learning | Batch |
|---|---|---|---|---|
| Dataset | Setting | H | Rate | Size |
| BOOL5 | EXPEMB-A | All | 10⁻⁴ | 8 |
| BOOL5 | EXPEMB-E | 64 | 2 × 10⁻⁴ | 64 |
| SIMPPOLY5 | EXPEMB-A | All | 5 × 10⁻⁵ | 8 |
| SIMPPOLY5 | EXPEMB-E | All | 5 × 10⁻⁵ | 16 |
| SIMPPOLY8 | EXPEMB-A | All | 10⁻⁴ | 16 |
| ONEV-POLY10 | EXPEMB-E | 64 | 2 × 10⁻⁴ | 64 |
| ONEV-POLY10 | EXPEMB-A | All except 64 | 5 × 10⁻⁵ | 8 |
| ONEV-POLY10 | EXPEMB-A | 64 | 10⁻⁴ | 8 |
| ONEV-POLY13 | EXPEMB-A | All | 5 × 10⁻⁵ | 32 |
| POLY5 | EXPEMB-E | All | 10⁻⁴ | 32 |
| POLY5 | EXPEMB-A | All | 5 × 10⁻⁵ | 8 |

A single Quadro RTX 6000 GPU was used for training EXPEMB-E on the dataset with longer expressions and a single V100 GPU was used for all other models. For the Equivalent Expressions Dataset, EXPEMB-A (H=128) took ˜1 hour and EXPEMB-E (H=1024) took ˜2 hours to train for an epoch. Both of these models were trained for 20 epochs. For the dataset with longer expressions, the training times per epoch were ˜4 hours and ˜20 hours for EXPEMB-A (H=128) and EXPEMB-E (H=2048), respectively. Table 14 shows the approximate training time per epoch (in seconds) for the SEMVEC datasets.

TABLE 14
Approximate training time in seconds per epoch for the SEMVEC datasets.

| | EXPEMB-A | | | | | EXPEMB-E | | | | |
|---|---|---|---|---|---|---|---|---|---|---|
| Dataset | H = 64 | 128 | 256 | 512 | 1024 | 64 | 128 | 256 | 512 | 1024 |
| SIMPBOOL8 | 17 | 19 | 18 | 19 | 21 | 3405 | 1921 | 2164 | 3313 | 2245 |
| SIMPBOOL10 | 12 | 12 | 14 | 12 | 13 | 1141 | 714 | 823 | 1391 | 850 |
| BOOL5 | 3 | 3 | 3 | 3 | 3 | 11 | 6 | 7 | 12 | 7 |
| BOOL8 | 111 | 127 | 129 | 135 | 119 | 11088 | 9706 | 7087 | 9737 | 12618 |
| BOOL10 | 22 | 26 | 25 | 24 | 26 | 2574 | 1504 | 1706 | 2719 | 1782 |
| SIMPBOOLL5 | 4 | 4 | 4 | 4 | 4 | 37 | 23 | 23 | 38 | 27 |
| BOOLL5 | 15 | 15 | 15 | 15 | 15 | 298 | 186 | 187 | 354 | 214 |
| SIMPPOLY5 | 1 | 1 | 1 | 1 | 1 | 2 | 2 | 2 | 2 | 2 |
| SIMPPOLY8 | 5 | 5 | 6 | 5 | 6 | 79 | 45 | 47 | 81 | 53 |
| SIMPPOLY10 | 27 | 26 | 30 | 27 | 27 | 7932 | 3089 | 3140 | 3153 | 3634 |
| ONEV-POLY10 | 4 | 4 | 4 | 5 | 5 | 22 | 18 | 13 | 23 | 14 |
| ONEV-POLY13 | 112 | 112 | 118 | 117 | 118 | 5958 | 5869 | 6041 | 6177 | 6994 |
| POLY5 | 2 | 2 | 2 | 2 | 2 | 2 | 2 | 2 | 2 | 2 |
| POLY8 | 5 | 5 | 6 | 6 | 6 | 183 | 102 | 103 | 187 | 120 |

For the Equivalent Expressions Dataset, the validation was performed using the model accuracy (as described above) with a beam size of 1. Table 15 shows the accuracy of EXPEMB-A and EXPEMB-E on the Equivalent Expressions Dataset and the dataset with longer expressions. Table 16 shows the scores, scoreₖ(q), achieved by the model described herein on the validation sets of the SEMVEC datasets.

TABLE 15
Accuracy of EXPEMB-A and EXPEMB-E on the validation
datasets of the Equivalent Expressions Dataset
and the dataset with longer expressions.

| | Equivalent Expressions | | Dataset with Longer | |
|---|---|---|---|---|
| Beam | Dataset | | Expressions | |
| Size | EXPEMB-A | EXPEMB-E | EXPEMB-A | EXPEMB-E |
| 1 | 1.0000 | 0.6015 | 0.9994 | 0.4341 |

TABLE 16
score₅(%) achieved by the models described herein
on the validation sets of the SEMVEC datasets.

| | EXPEMB-A | | | | | EXPEMB-E | | | | |
|---|---|---|---|---|---|---|---|---|---|---|
| Dataset | H = 64 | 128 | 256 | 512 | 1024 | 64 | 128 | 256 | 512 | 1024 |
| SIMPBOOL8 | 23.8 | 22.5 | 21.4 | 26.0 | 24.1 | 95.4 | 96.9 | 98.0 | 99.4 | 99.6 |
| SIMPBOOL10 | 6.4 | 8.8 | 5.5 | 6.6 | 6.8 | 54.0 | 56.2 | 80.4 | 67.1 | 71.5 |
| BOOL5 | 17.9 | 15.6 | 19.2 | 20.8 | 21.5 | 57.4 | 45.7 | 52.8 | 52.4 | 53.2 |
| BOOL8 | 11.3 | 11.8 | 13.2 | 16.3 | 15.0 | 98.1 | 99.9 | 100.0 | 100.0 | 100.0 |
| BOOL10 | 1.8 | 2.3 | 2.0 | 1.8 | 2.1 | 26.0 | 34.4 | 37.9 | 67.9 | 74.6 |
| SIMPBOOLL5 | 23.4 | 22.5 | 24.6 | 25.2 | 26.0 | 51.7 | 75.3 | 73.1 | 74.3 | 75.3 |
| BOOLL5 | 11.7 | 15.2 | 11.0 | 14.3 | 14.6 | 66.0 | 69.7 | 73.7 | 67.4 | 64.3 |
| SIMPPOLY5 | 25.9 | 25.9 | 29.6 | 18.5 | 22.2 | 33.3 | 40.7 | 37.0 | 40.7 | 33.3 |
| SIMPPOLY8 | 15.4 | 15.2 | 14.3 | 15.2 | 12.6 | 50.0 | 74.5 | 91.6 | 80.6 | 78.0 |
| SIMPPOLY10 | 11.7 | 12.7 | 11.0 | 10.5 | 11.0 | 99.3 | 99.3 | 99.4 | 99.4 | 99.4 |
| ONEV-POLY10 | 24.5 | 29.7 | 28.9 | 24.6 | 26.8 | 27.3 | 32.6 | 53.7 | 58.9 | 61.8 |
| ONEV-POLY13 | 19.8 | 22.1 | 20.2 | 20.5 | 20.0 | 91.8 | 98.2 | 98.7 | 98.7 | 98.7 |
| POLY5 | 27.8 | 22.2 | 16.7 | 16.7 | 16.7 | 44.4 | 55.6 | 50.0 | 41.7 | 33.3 |
| POLY8 | 10.3 | 14.6 | 15.0 | 15.5 | 12.1 | 61.6 | 82.4 | 81.5 | 85.1 | 84.3 |

The models and methods of training thereof described herein use training dataset of pairs or other-sized sets of mathematically equivalent expressions. The quality of such models, or of other trained models that operate on such mathematical expressions, can be improved by using larger, more diverse training datasets. However, obtaining or generating such large datasets of mathematically equivalent expressions can be difficult.

Also provided herein is an effective, computationally tractable method of generating, from a single input mathematical expression, a set of mathematically equivalent expressions. Such sets of mathematically equivalent expressions can then be used to train a model as described herein (e.g., by sampling pairs of equivalent expressions from the set(s) of equivalent expressions) or to train some other model that operates on and/or is trained based on pairs or larger-sized sets of mathematically equivalent expressions.

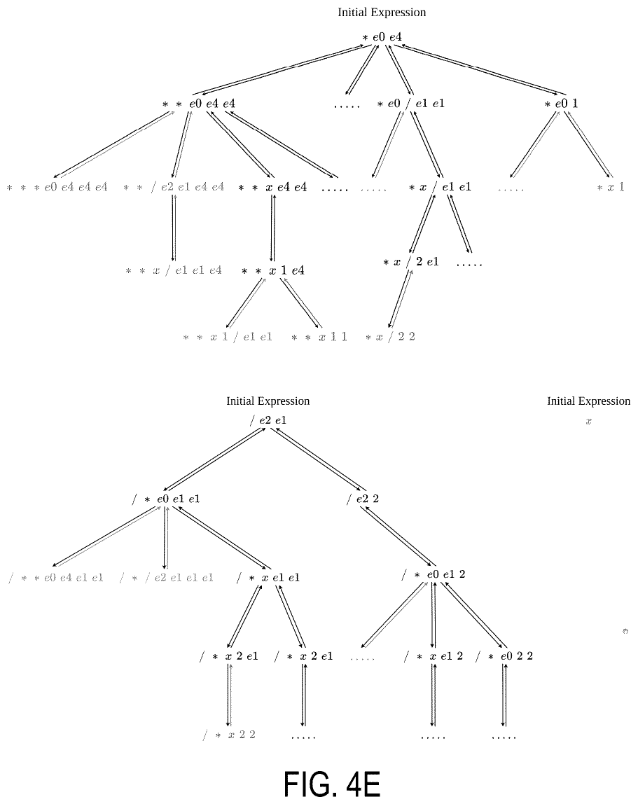

This improved “extraction algorithm” generates, from a single input mathematical expression, an e-graph representation of the input expression that is then expanded into a “saturated” e-graph representation by applying mathematical rewrite rules to expand the representation until the rewrite rules can no longer be applied. This saturated e-graph representation is then translated into a mathematical “grammar” that represents each node of the saturated e-graph. The mathematical grammar is then used to extract mathematically equivalent expressions to the input expression, starting from the root e-class of the saturated e-graph and repeatedly applying the corresponding grammar to rewrite the expressions until the expressions contain only operators, variables, and/or constants. This extraction process may be applied to many different possible traversals of the grammar, thereby extracting all, or a large fraction, of the possible mathematically equivalent expressions to the input expression. Aspects of this extraction algorithm 400 are illustrated in FIG. 4A.

Such an extraction algorithm provides a variety of benefits, as it allows a relatively small number of available mathematical expressions, which may not be associated into pairs or larger sets of mathematically equivalent expressions, to be used to generate therefrom large sets of mathematically equivalent expressions that can then be used for a variety of applications, e.g., to train a model as described herein to generate semantically-representative vector embeddings for novel input mathematical expressions. Further, this extraction algorithm provides these benefits in a computationally tractable, efficient manner by using rewrite rules that are computationally cheap to perform to translate an input expression into a saturated e-graph that can then be used, in a multi-threaded or otherwise parallelize-able manner, to extract a number (potentially all possible) mathematically equivalent expressions to the input expression. This extraction process is relatively lightweight with respect to memory, as it involves traversal of the grammar generated from the saturated e-graph to progressively replace the e-node sequence representing the expression, using the grammar, with operators, variables, and/or constants that represent a particular extracted mathematical expression.

Elements of this extraction algorithm are explained in greater detail below, in the form of specific examples and example implementations. However, one of skill in the art will appreciate that alternative or additional aspects to those below can be applied to these specifics without departing from the scope of the present embodiments.

E-graphs are a data structure to represent mathematical equations that allows for efficient manipulation of collections of terms along with a congruence relation over those terms. E-graphs were initially developed for theorem provers and have appeared in applications in various areas, including program optimization and language processing.

At a high level, an e-graph is composed of e-classes, which contain equivalent e-nodes. Each e-node can have one or several children e-classes, depending on how the corresponding symbol is declared. For instance, binary operators like addition, subtraction, multiplication, and division have two children e-classes, while unary operators like square root, exponential, trigonometric, and hyperbolic functions have only one child e-class.

In mathematical expression processing, e-graphs are used in various ways, with one common approach being equality saturation. This process involves applying a series of rewriting rules to an expression until it is in a canonical form that is equivalent to the original expression. Equality saturation is useful for simplification, optimization, and transformation of expressions.

Context-free and context-sensitive grammars are formal rule sets used to describe the syntax and structure of a language. In the context of mathematical expressions, context-free grammars (CFGs) are often used to specify expression syntax, while context-sensitive grammars (CSGs) are used to specify semantic rules.

CFGs consist of a set of production rules that describe how to form valid expressions from basic symbols or variables. The rules take the form of “A→B”, where A is a non-terminal symbol and B is a sequence of symbols that can include variables or non-terminals. For example, a simple CFG rule for a mathematical expression could be “Exp→Exp+Exp”, meaning an expression can be formed by combining two sub-expressions with a plus operator.

CSGs are more complex and allow for context-dependent rules, taking into account the surrounding expression's context, such as the types of variables and operators used. This allows for more precise control over the meaning and interpretation of expressions. For example, a CSG rule could enforce that a division operator is only valid when the denominator is not zero.

The first step in the extraction algorithm 400 involves constructing the initial e-graph using the input mathematical expression. Since the input expression may contain multiple parentheses, it can be parsed to extract the information of each e-node in the initial e-graph representation thereof. This e-graph representation will likely include several e-classes, with each e-class containing one or more e-nodes that represent sub-expressions of the input expression. An example of this initialization step is illustrated in FIG. 4B, where an input equation (2x)/2 (represented in Polish notation a/* x2 2) is converted into an e-graph. In the example of FIG. 4B, each e-class contains a single e-node.

The next step in the extraction algorithm 400 is to saturate the initial e-graph to arrive at a saturated e-graph by applying a series of mathematical rewrite rules until the rewrite rules can no longer be applied. An example of the initial e-graph and a saturated e-graph generated therefrom by such a process is depicted in FIG. 4C. These mathematical rewrite rules can be represented as equations such as “?x=?x*1”, “?x=?x+0”, and “?x * ?y=?y * ?x,” among others. Note that the ?x and ?y here do not necessarily represent variables only, but could also be expressions. The ? in front of the x and y indicates that they could take any form, such as variables or expressions, as long as the pattern is maintained. The objective of this phase is to transform the e-graph into a saturated form where no more mathematical rewrite rules can be applied.

The next step in the extraction algorithm 400 is to generate a mathematical grammar that represents the saturated e-graph in a way that allows equivalent e-nodes within the same e-class to be identified. An example of an input saturated e-graph and a mathematical grammar generated therefrom by such a process is depicted in FIG. 4D. The saturated e-graph of FIG. 4D has 4 e-classes and 7 e-nodes; the number at the top-left corner of each e-class indicates the id of each e-class. A total of 7 replacement expressions are created therefrom, one for each e-node and organized into four sets of one or more replacement expressions according to their corresponding e-classes. For instance, e-class “e0” contains three equivalent e-nodes, represented by a set of replacement expressions “* e0 e4”, “/e2 el”, and “x”. This information implies that any string containing e-class “e0” could have the “e0” replaced with any of the aforementioned expressions to generate a string representing a different yet equivalent mathematical expression. Thusly, the original e-graph data structure is converted into a context-free or context-sensitive grammar form that can be utilized to perform rewriting during extraction.

The final stage of the extraction algorithm 400 is to extract all (or a large number) of the possible equivalent mathematical expressions from the grammar created in the previous step. To ensure the extracted results are equivalent to the initial mathematical expression, one can start the extraction from the root e-class of the saturated e-graph, which may contain one or more e-nodes. To obtain all equivalent expressions, the extraction algorithm must be applied to all e-nodes within the root e-class. An example of an input saturated e-graph and the replacement expressions corresponding to each of the e-nodes (a total of three) in the root e-class thereof is depicted in FIG. 4D.

This extraction step is a recursive function that is called repeatedly until all the operands in the string are mathematical operators, variables, or constants. For instance, the string “+e0 * 5 y” is not considered a complete mathematical expression since it still contains an e-class, while the string “+x * 5 y” is considered complete since it only contains mathematical operators, variables, and constants.

In practice, some additional constraints can be applied to the extraction algorithm, since a terminating condition may be required for many grammars/e-graphs in order to avoid infinite recursive calls. In such cases, an infinite loop condition is possible, such as when root e-class “e0” contains an e-node that corresponds to a replacement expression that references class “e0” (e.g., “* e0 e1”). Such an e-class will be repeatedly rewritten with itself and never reach a terminating condition. To solve this problem, a maximum string length condition can be applied to the generation of the final mathematical expression. If the current string length exceeds the limit set by the user, the algorithm will skip the current rewrite for the current e-class and move to the next rewrite for that e-class.

FIG. 4E shows the results of such an extraction process for the e-graph and grammar depicted in FIGS. 4B-D. The top expression extraction graph starts with the initial expression “* e0 e4,” the bottom left starts with the initial expression “/e2 e1,” and the bottom right starts with the initial expression “x.”. Black arrows shows the subsequent recursive call on the new string, red arrows indicate unsuccessful returns due to the rewrite string exceeding the length limit (6, in this example, though longer or shorter limits may be chosen), while green arrows represent successful extractions with a successful return. These examples illustrate several benefits of the extraction algorithm described herein, including the relative simplicity of the algorithm and its low cost with respect to memory requirements, its generation of only non-identical but mathematically equivalent expression sequences, and its ability to be readily parallelized by, e.g., partitioning the space of the e-graph amongst multiple different threads/processors. For example, each e-node in the root e-class could be assigned to a respective difference thread/processor.

Additionally or alternatively, each recursive call to expand the expression could be allocated to a separate child thread, so long as the total number of threads (including both main and child threads) does not exceed a thread limit of the operating system. This approach can allow available computing resources to be fully utilized in order to execute multiple recursive calls in parallel, thereby accelerating the overall extraction process. The multi-threaded approach offers considerable advantages to the extraction algorithm, as the recursive nature of the algorithm can lead to slow performance. By enabling the simultaneous execution of multiple threads, the speed of the algorithm can be significantly improved, resulting in increased efficiency.

In such multi-threaded implementations of the extraction algorithm, a global variable can be initialized and used to collect all final equivalent mathematical expressions from each thread, as different threads will produce different final results during extraction. In such a scenario, a mutual exclusion (or “mutex”) can be used to protect the global variable, since all threads will attempt to change its contents at some point during the extraction process. To prevent the loss of data that may occur if multiple threads attempt to insert a value into the vector simultaneously and only one insertion succeeds, each thread must first attempt to lock the global variable. If successful, the thread can insert its final result into the vector. If unsuccessful, the thread will have to wait until the lock is released by another thread before attempting to lock the variable again. Therefore, using a mutex ensures that all threads properly synchronize on the shared data, providing mutual exclusion and ensuring that only one thread can access the shared data at a time.

To further improve the implementation of an extraction algorithm as described herein, a vector can be created that identifies e-classes to skip under certain conditions, e.g., where some non-meaningful rewrites, such as “x⇒x*1”, should be omitted. An e-node representing a 64-bit float constant will be the only e-node in its corresponding e-class; therefore, it is possible to determine if an e-class contains a constant by checking the length of its e-nodes vector. If the vector has a length of one, the e-node can be converted into a string and attempted to parse as a 64-bit float variable. If parsing is successful and the value matches the target (in this example, either 1.0 or 0.0), the e-class id concatenated with the character ‘e,’ and the 64-bit float, can be stored as a key-value pair in a HashMap. During extraction, to check if an e-class is a constant e-class and which constant it represents, the value can be retrieved quickly using the e-class id with a speed of O(1). This method is beneficial for the purposes described herein since it enables quickly retrieval of the relevant information when needed.

In the process of extraction, there exists several rewrite rules, known as expansions, that can be applied to almost all e-nodes, including “x⇒x*1”, “x⇒x+0”, and “x⇒x¹”. These expansions, however, can significantly slow down the extraction process and produce numerous irrelevant rewrites in the final results. To address this issue and reduce the computational cost of the extraction algorithm described herein, the extraction algorithm can be augmented with function to detect such non-desired expansions and reject them. Such a function takes the proposed rewrite as input and checks whether it contains the three aforementioned patterns. If the input contains the specific e-class and their anticipated operator, the function returns true. This result signals to the extract function that the current rewrite should be skipped, and the program should proceed to the next one, thereby avoiding redundant recursive function calls.

By implementing this specialized function, the extraction process can be improved and streamlined, reducing the likelihood of generating superfluous and redundant rewrites. This results in more efficient and meaningful extraction outcomes, providing a significant improvement to the overall efficiency of the extraction algorithm.

For the extraction algorithm described herein (e.g., 400), a variety of different mathematical rewrite rules can be used to expand an initial e-graph into a saturated e-graph that can then be used for subsequent steps of the algorithm. Such mathematical rewrite rules could include, but not necessarily be limited to, any set or subset of the following: Commutative properties:

| Arithmetic Operation | Commutative Property |
|---|---|
| addition-2var | (+ ?x ?y) => (+ ?y ?x) |
| multiplication-2var | (* ?x ?y) => (* ?y ?x) |

Associative properties:

| Arithmetic Operation | Associative Property |
|---|---|
| addition-3var | (+ (+ ?x ?y) ?z) => (+ ?x (+ ?y ?z)) |
| | (+ ?x (+ ?y ?z)) => (+ (+ ?x ?y) ?z) |
| multiplication-3var | (* (* ?x ?y) ?z) => (* ?x (* ?y ?z)) |
| | (* ?x (* ?y ?z)) => (* (* ?x ?y) ?z) |
| multiplication-division | (/ (* ?x ?y) ?z) => (* ?x (/ ?y ?z)) |
| | (/ (* ?x ?y) ?z) => (* ?y (/ ?x ?z)) |

Distributive properties:

| Arithmetic Operation | Distributive Property |
|---|---|
| multiplication-addition | (* ?x (+ ?y ?z)) => (+ (* ?x ?y) (* ?x ?z)) |
| multiplication-subtraction | (* ?x (− ?y ?z)) => (− (* ?x ?y) (* ?x ?z)) |

Identity properties:

| Arithmetic Operation | Identity Property |
|---|---|
| addition | (+ ?x 0) => ?x |
| subtraction | (− ?x 0) => ?x |
| multiplication | (* ?x 1) => ?x |
| division | (/ ?x 1) => ?x |
| exponent | (exp ?x 1) => ?x |

Properties of Simplification:

| Arithmetic Operation | Property of Simplification |
|---|---|
| multiplication | (* ?x 0) => 0 |
| | (* −1 −1) => 1 |
| | (* ?x (/ 1 ?x)) => 1 if not_zero(“?x”) |
| subtraction | (− ?x ?x) => 0 |
| division | (/ ?x ?x) => 1 if not_zero(“?x”) |

Properties of Exponent:

| Name | Exponent Property |
|---|---|
| Zero Property | (pow ?x 0) => 1 |
| Negative Property | (pow ?x −1) => (/ 1 ?x) if not_zero(“?x”) |
| Product of Powers | (* (pow ?x ?y) (pow ?x ?z)) => (pow ?x (+ ?y ?z)) |
| Quotient of Powers | (/ (pow ?x ?y) (pow ?x ?z)) => (pow ?x (− ?y ?z)) |
| Power of a Power | (pow (pow ?x ?y) ?z) => (pow ?x (* ? y ?z)) |
| Power of a Product | (pow (* ?x ?y) ?z) => (* (pow ?x ?z) (pow ?y ?z)) |
| Power of a Quotient | (pow (/ ?x ?y) ?z) => (/ (pow ?x ?z) (pow ?y ?z)) |

Properties of Logarithm:

| Name | Property of Logarithm |
|---|---|
| change-of-base | (log ?y ?x) => (/ (log ?b ?x) (log ?b ?y)) |
| multiplication | (log ?a (* ?x ?y)) => (+ (log ?a ?x) (log ?a ?y)) |
| | (ln (* ?x ?y)) => (+ (ln ?x) (ln ?y)) |
| division | (log ?a (/ ?x ?y)) => (− (log ?a ?x) (log ?a ?y)) |
| | (ln (/ ?x ?y)) => (− (ln ?x) (ln ?y)) |
| power | (log ?a (pow ?x ?y) ) => (* y (log ?a ?x)) |
| | (ln (pow ?x ?y)) => (* y (ln ?x)) |

Trigonometric Identities:

| Name | Trigonometric Identity |
|---|---|
| tangent | (tan ?x) => (/ (sin ?x) (cos ?x)) |
| | (cot ?x) => (/ (cos ?x) (sin ?x)) |
| reciprocal | (csc ?x) => (/ 1 (sin ?x)) |
| | (sec ?x) => (/ 1 (cos ?x)) |
| | (cot ?x) => (/ 1 (tan ?x)) |
| Pythagorean | (+ (pow (sin ?x) 2) (pow (cos ?x) 2)) => 1 |
| theorem | (+ (pow (tan ?x) 2) 1) => (pow (sec ?x) 2) |
| | (+ (pow (cot ?x) 2) 1) => (pow (csc ?x) 2) |
| even/odd | (sin (* −1 ?x)) => (* −1 (sin ?x)) |
| | (cos (* −1 ?x)) => (cos ?x) |
| | (tan (* −1 ?x)) => (* −1 (tan ?x)) |

Properties of Derivatives:

| Name | Property of Derivative |
|---|---|
| constant | (d ?x ?c) => 0 if is_const (“?c”) |
| power | (d ?x (pow ?x ?c)) => (* ?c (pow ?x (− ?c 1))) if |
| | is_const(“7c”) |
| multiplication | (d ?x (* ?c ?a)) => (* ?c (d ?x ?a)) if |
| | is_const(“?c”) |
| distributive | (d ?x (+ ?a ?b)) => (+ (d ?x ?a) (d ?x ?b)) |
| | (d ?x (− ?a ?b)) => (− (d ?x ?a) (d ?x ?b)) |
| trigonometry | (d ?x (sin ?x)) => (cos ?x) |
| | (d ?x (cos ?x)) => (* −1 (sin ?x)) |
| | (d ?x (tan ?x)) => (pow (sec ?x) 2) |
| | (d ?x (sec ?x)) => (* (sec ?x) (tan ?x)) |
| | (d ?x (csc ?x)) => (* −1 (* (csc ?x) (cot ?x))) |
| | (d ?x (cot ?x)) => (* −1 (pow (csc ?x) 2)) |
| logarithm | (d ?x (log ?b ?x)) => (/ 1 (* ? x ln ?a)) |
| | (d ?x (ln ?x)) => (/ 1 ?x) if not_zero(“?x”) |

and/or other properties (e.g., properties of integrals).

The extraction algorithm described herein was implemented and used to generate the following sets of extraction results from the following example input initial mathematical expressions:

| | |
|---|---|
| Input Expression | Extraction Results |

| | | |
|---|---|---|
| cos(2x) | cos(2x) | cos(2x) × 1 |
| | cos(−2x) | cos(x + x) |
| | cot(2x) sin(2x) | 2cos²(x) − 1 |
| | sin(2x)/tan(2x) | sin(2x) cot(2x) |

| | |
|---|---|
| Input Expression | Extraction Results |

| | | |
|---|---|---|
| sec(x)/sin(x) | sec(x)/sin(x) | csc(x) sec(x) |
| | csc(x)/cos(x) | cot(x) sec²(x) |
| | sin⁻¹(x) sec(x) | tan(x) csc²(x) |
| | sin⁻²(x) tan(x) | csc(x) tan(x)/sin(x) |
| | sec(x) cot(x)/cos(x) | −csc(−x) sec(x) |
| | tan(x) + cot(x) | csc(x)/cos(x) |
| | 1/(sin(x) cos(x)) | tan(x) (cot²(x) + 1) |
| | csc(x)/(sin(x)/tan(x)) | (sec(x)/tan(x))/cos(x) |

| Input Expression | Extraction Results | |
|---|---|---|
| $\frac{d}{dx} tan ( x )$ | sec(x)/cos(x) csc(x)sec(x)tan(x) | sec³(x)cos(x) tan²(x) + 1 |
| | (cot(x) + tan(x))tan(x) | csc(x)tan(x)/cos(x) |
| | sec(x)tan (x)sin(x) | sec²(x) |
| | cos⁻²(x) | (csc(x)tan(x))² |
| | (csc(x)tan(x))² | (tan(x)/sin(x))/cos(x) |
| | $\frac{d}{dx} tan ( x )$ | $\frac{d}{dx} ( - tan ( - x ) )$ |
| | $\frac{d}{dx} ( sin ( x ) / cos ( x ) )$ | ${( cos ( x ) \frac{d}{dx} tan ( x ) )}^{2}$ |

| Input Expression | Extraction Results | |
|---|---|---|
| $\frac{d}{dx} ( {x}^{2} + 2 x + 1 )$ | 2(x + 1) 2(x + 1) × 1 | 2x + 2 2(x + 1) + 1 |
| | $2 + \frac{d}{dx} {x}^{2}$ | $\frac{d}{dx} ( {x}^{2} + 2 x )$ 1 |

### II. Example Systems

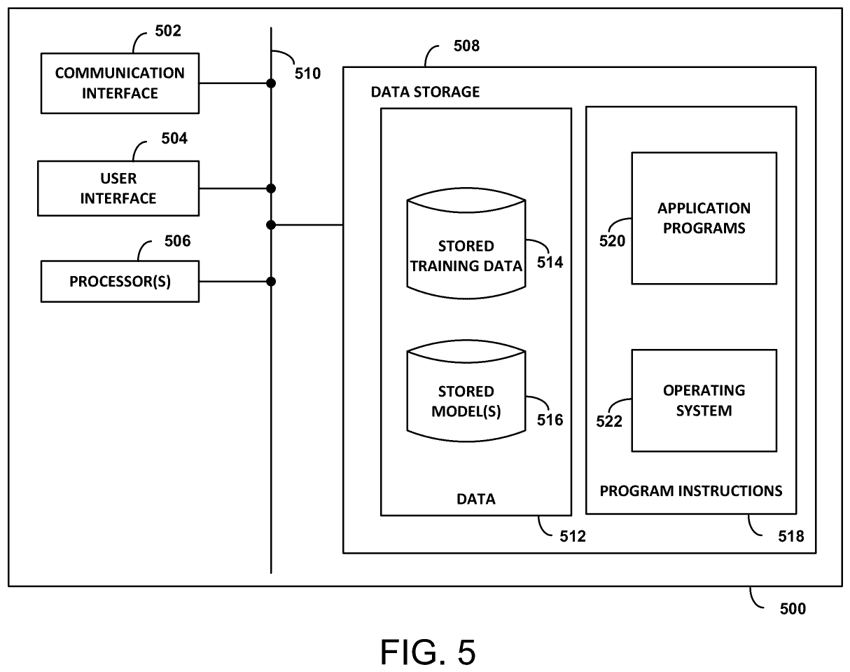

FIG. 5 illustrates an example system 500 that may be used to implement the methods described herein. By way of example and without limitation, system 500 may be or include a computer (such as a desktop, notebook, tablet, or handheld computer, a server), elements of a cloud computing system, or some other type of device or system. It should be understood that elements of system 500 may represent a physical instrument and/or computing device such as a server, a particular physical hardware platform on which applications operate in software, or other combinations of hardware and software that are configured to carry out functions as described herein.

As shown in FIG. 5, system 500 may include a communication interface 502, a user interface 504, one or more processor(s) 506, and data storage 508, all of which may be communicatively linked together by a system bus, network, or other connection mechanism 510.

Communication interface 502 may function to allow system 500 to communicate, using analog or digital modulation of electric, magnetic, electromagnetic, optical, or other signals, with other devices, access networks, and/or transport networks. Thus, communication interface 502 may facilitate circuit-switched and/or packet-switched communication, such as plain old telephone service (POTS) communication and/or Internet protocol (IP) or other packetized communication. For instance, communication interface 502 may include a chipset and antenna arranged for wireless communication with a radio access network or an access point. Also, communication interface 502 may take the form of or include a wireline interface, such as an Ethernet, Universal Serial Bus (USB), or High-Definition Multimedia Interface (HDMI) port. Communication interface 502 may also take the form of or include a wireless interface, such as a Wifi, BLUETOOTH®, global positioning system (GPS), or wide-area wireless interface (e.g., 3GPP Long-Term Evolution (LTE), or 3GPP 5G). However, other forms of physical layer interfaces and other types of standard or proprietary communication protocols may be used over communication interface 502. Furthermore, communication interface 502 may comprise multiple physical communication interfaces (e.g., a Wifi interface, a BLUETOOTH® interface, and a wide-area wireless interface).

In some embodiments, communication interface 502 may function to allow system 500 to communicate, with other devices, remote servers, access networks, and/or transport networks. For example, the communication interface 502 may function to communicate with one or more servers (e.g., servers of a cloud computer system that provide computational resources for a fee) to provide input mathematical expressions (or representations thereof) and to receive, in response, vector embeddings representing the input mathematical expressions determined as described herein, lists or representations of other mathematical expressions that are similar to the input expression with respect to such a vector embedding, lists or representations of journal articles, books, or other records that contain such similar mathematical expressions (e.g., citations to such references, which may include information sufficient to locate such expressions within such references), or other types of data or references thereto that are semantically related to the input mathematical expression, as described herein. In another example, the communication interface 502 may function to receive such input mathematical expressions or representations thereof and to transmit in response such vector embeddings, reference lists, or other information that is relevant to the semantic content of the input expression. In yet another example, the communication interface 502 may function to communicate with one or more cellphones, tablets, or other computing devices.

User interface 504 may function to allow system 500 to interact with a user, for example to receive input from and/or to provide output to the user. Thus, user interface 504 may include input components such as a keypad, keyboard, touch-sensitive or presence-sensitive panel, computer mouse, trackball, joystick, microphone, and so on. User interface 504 may also include one or more output components such as a display screen which, for example, may be combined with a presence-sensitive panel. The display screen may be based on CRT, LCD, and/or LED technologies, or other technologies now known or later developed. User interface 504 may also be configured to generate audible output(s), via a speaker, speaker jack, audio output port, audio output device, earphones, and/or other similar devices.

Processor(s) 506 may comprise one or more general purpose processors—e.g., microprocessors—and/or one or more special purpose processo—e.g., digital signal processors (DSPs), graphics processing units (GPUs), floating point units (FPUs), network processors, tensor processing units (TPUs), or application-specific integrated circuits (ASICs). In some instances, special purpose processors may be capable of model execution (e.g., execution of artificial neural networks or other machine learning models, execution of a GRU or other recurrent model), training of models, generation of training datasets for the training of models, or other functions as described herein, among other applications or functions. Data storage 508 may include one or more volatile and/or non-volatile storage components, such as magnetic, optical, flash, or organic storage, and may be integrated in whole or in part with processor(s) 506. Data storage 508 may include removable and/or non-removable components.

Processor(s) 506 may be capable of executing program instructions 518 (e.g., compiled or non-compiled program logic and/or machine code) stored in data storage 508 to carry out the various functions described herein. Therefore, data storage 508 may include a non-transitory computer-readable medium, having stored thereon program instructions that, upon execution by system 500, cause system 500 to carry out any of the methods, processes, or functions disclosed in this specification and/or the accompanying drawings. The execution of program instructions 518 by processor(s) 506 may result in processor 506 using data 512. By way of example, program instructions 518 may include an operating system 522 (e.g., an operating system kernel, device driver(s), and/or other modules) and one or more application programs 520 (e.g., functions for executing the methods described herein) installed on system 500. Data 512 may include stored training data 514 (e.g., pairs or other-numbered sets of equivalent mathematical expressions). Data 512 may also include stored models 516 (e.g., stored model parameters and other model-defining information) that can be executed as part of the methods described herein (e.g., to determine, from an input mathematical expression, a continuous vector representation of the input expression).

Application programs 520 may communicate with operating system 522 through one or more application programming interfaces (APIs). These APIs may facilitate, for instance, application programs 520 transmitting or receiving information via communication interface 502, receiving and/or displaying information on user interface 504, and so on.

Application programs 520 may take the form of “apps” that could be downloadable to system 500 through one or more online application stores or application markets (via, e.g., the communication interface 502). However, application programs can also be installed on system 500 in other ways, such as via a web browser or through a physical interface (e.g., a USB port) of the system 500.

### III. Example Methods

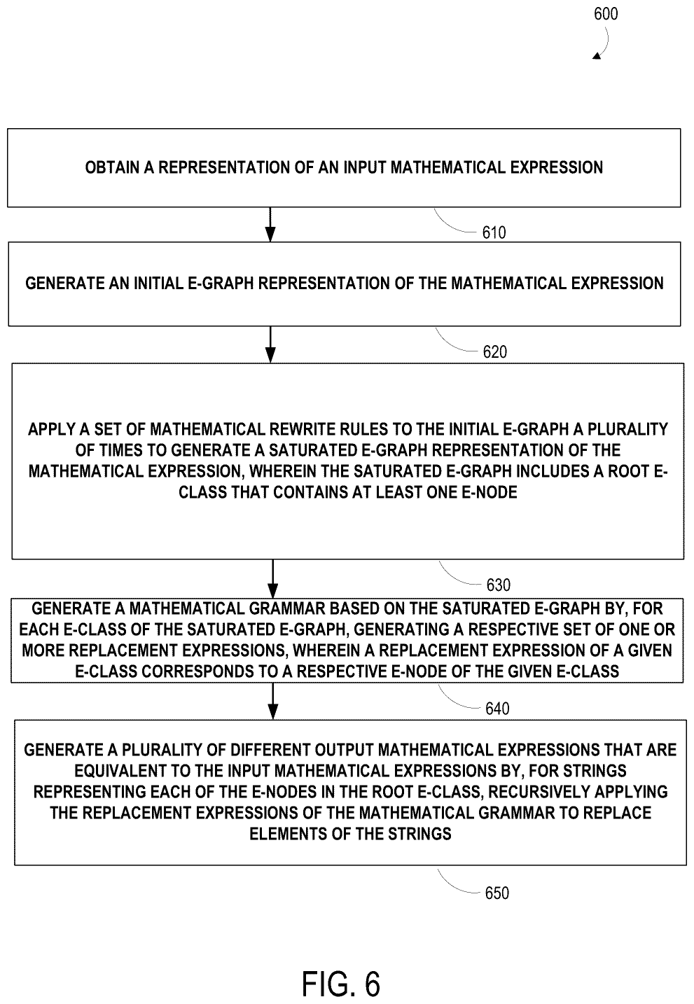

FIG. 6 is a flow chart illustrating an example method 600. The method 600 may be combined with features, aspects, and/or implementations of any of the previous figures or other embodiments otherwise described herein. The method 600 includes obtaining a representation of an input mathematical expression (610). The method 600 also includes generating an initial e-graph representation of the mathematical expression (620). The method 600 additionally includes applying a set of mathematical rewrite rules to the initial e-graph a plurality of times to generate a saturated e-graph representation of the mathematical expression, wherein the saturated e-graph includes a root e-class that contains at least one e-node (630). The method 600 yet further includes generating a mathematical grammar based on the saturated e-graph by, for each e-class of the saturated e-graph, generating a respective set of one or more replacement expressions, wherein a replacement expression of a given e-class corresponds to a respective e-node of the given e-class (640). The method 600 also includes generating a plurality of different output mathematical expressions that are equivalent to the input mathematical expressions by, for strings representing each of the e-nodes in the root e-class, recursively applying the replacement expressions of the mathematical grammar to replace elements of the strings (650). The method 600 could include additional or alternative elements or aspects to those depicted in FIG. 6.

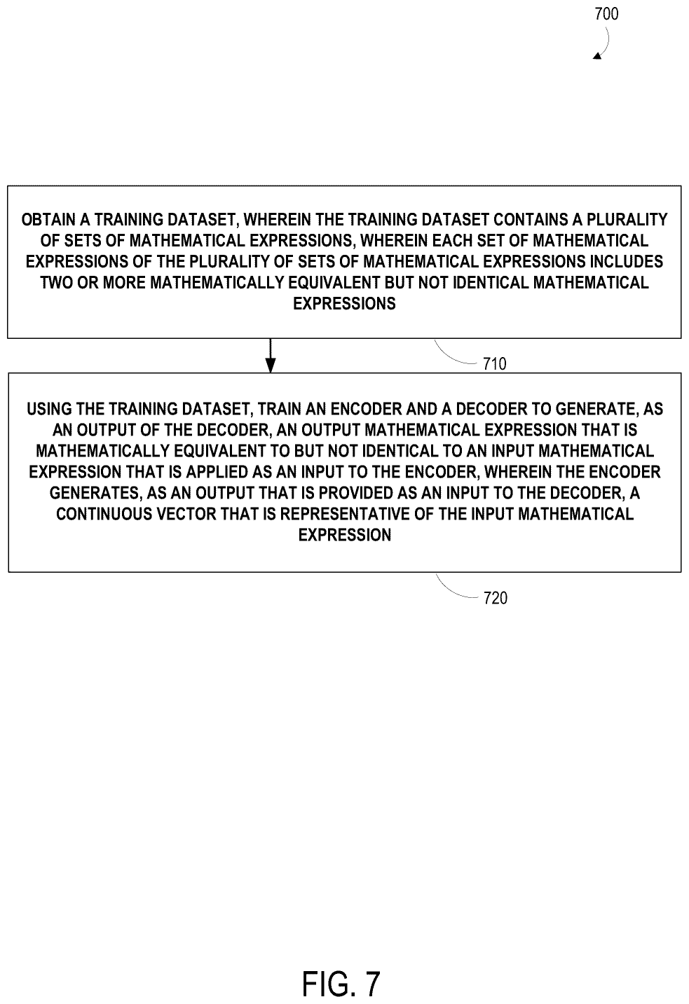

FIG. 7 is a flow chart illustrating an example method 700. The method 700 may be combined with features, aspects, and/or implementations of any of the previous figures or other embodiments otherwise described herein. The method 700 includes obtaining a training dataset, wherein the training dataset contains a plurality of sets of mathematical expressions, wherein each set of mathematical expressions of the plurality of sets of mathematical expressions includes two or more mathematically equivalent but not identical mathematical expressions (710). The method 700 also includes using the training dataset, training an encoder and a decoder to generate, as an output of the decoder, an output mathematical expression that is mathematically equivalent to but not identical to an input mathematical expression that is applied as an input to the encoder, wherein the encoder generates, as an output that is provided as an input to the decoder, a continuous vector that is representative of the input mathematical expression (720). The method 700 could include additional or alternative elements or aspects to those depicted in FIG. 7.

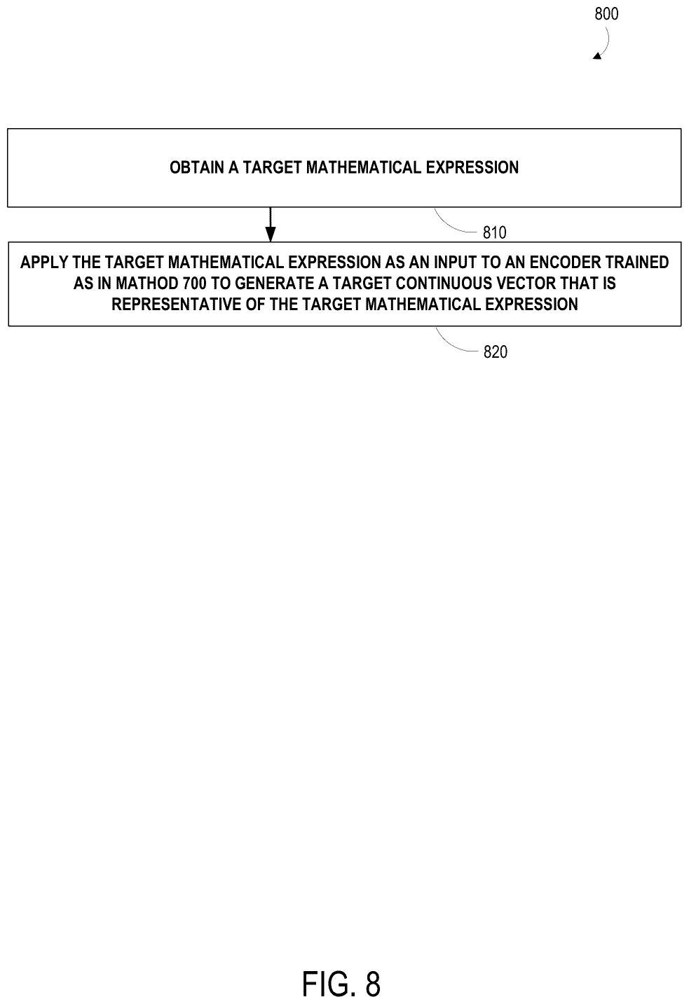

FIG. 8 is a flow chart illustrating an example method 800. The method 800 may be combined with features, aspects, and/or implementations of any of the previous figures or other embodiments otherwise described herein. The method 800 includes obtaining a target mathematical expression (810). The method 800 also includes applying the target mathematical expression as an input to an encoder trained as in method 700 to generate a target continuous vector that is representative of the target mathematical expression (820). The method 800 could include additional or alternative elements or aspects to those depicted in FIG. 8.

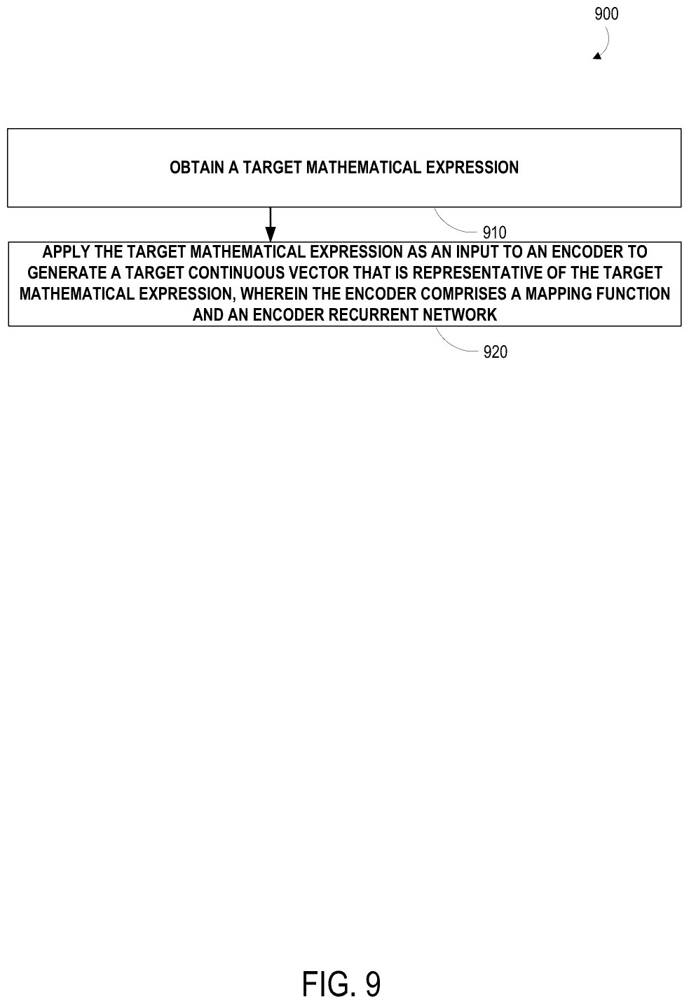

FIG. 9 is a flow chart illustrating an example method 900. The method 900 may be combined with features, aspects, and/or implementations of any of the previous figures or other embodiments otherwise described herein. The method 900 includes obtaining a target mathematical expression (910). The method 900 also includes applying the target mathematical expression as an input to an encoder to generate a target continuous vector that is representative of the target mathematical expression, wherein the encoder comprises a mapping function and an encoder recurrent network (920). Applying the target mathematical expression to the encoder to generate the target continuous vector includes: (i) parsing the target mathematical expression into an input ordered sequence of mathematical symbols; (ii) applying each of the mathematical symbols of the input ordered sequence of mathematical symbols to the mapping function to generate respective embedding vectors, thereby generating an ordered sequence of embedding vectors that represent the input ordered sequence of mathematical symbols in an embedding space; and (iii) executing the encoder recurrent network a plurality of iterations, wherein executing the encoder recurrent network a given first iteration of the plurality of iterations comprises generating a first output hidden vector in the embedding space based on (a) a second output hidden vector generated from a prior execution of the encoder recurrent network and (b) a first embedding vector of the ordered sequence of embedding vectors that corresponds to the first iteration, and wherein the continuous vector that is representative of the input mathematical expression is an output of the encoder recurrent network a final iteration of the plurality of iterations. The method 900 could include additional or alternative elements or aspects to those depicted in FIG. 9.

### IV. Conclusion

It should be understood that arrangements described herein are for purposes of example only. As such, those skilled in the art will appreciate that other arrangements and other elements (e.g. machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

### V. Enumerated Example Embodiments

Embodiments of the present disclosure may thus relate to one of the enumerated example embodiments (EEEs) listed below. It will be appreciated that features indicated with respect to one EEE can be combined with other EEEs.

EEE 1 is a computer-implemented method including: (i) obtaining a representation of an input mathematical expression; (ii) generating an initial e-graph representation of the mathematical expression; (iii) applying a set of mathematical rewrite rules to the initial e-graph a plurality of times to generate a saturated e-graph representation of the mathematical expression, wherein the saturated e-graph includes a root e-class that contains at least one e-node; (iv) generating a mathematical grammar based on the saturated e-graph by, for each e-class of the saturated e-graph, generating a respective set of one or more replacement expressions, wherein a replacement expression of a given e-class corresponds to a respective e-node of the given e-class; and (v) generating a plurality of different output mathematical expressions that are equivalent to the input mathematical expressions by, for strings representing each of the e-nodes in the root e-class, recursively applying the replacement expressions of the mathematical grammar to replace elements of the strings.

EEE 2 is the computer-implemented method of EEE 1, further comprising: sampling the plurality of different output mathematical expressions to generate a plurality of pairs of different mathematically equivalent expressions.

EEE 3 is the computer-implemented method of any of EEEs 1-2, wherein recursively applying the replacement expressions of the mathematical grammar to replace elements of the strings includes terminating the recursion if the number of elements in the rewritten string exceeds a specified maximum number of elements.

EEE 4 is the computer-implemented method of any of EEEs 1-3, wherein generating the saturated e-graph representation of the mathematical expression includes detecting whether a potential rewrite rule matches any rewrite rule of a specified set of non-desired expansions and, responsive to determining that the potential rewrite rule does not match any rewrite rule of the specified set, applying the potential mathematical rewrite rule to the initial e-graph.

EEE 5 is a computer-implemented method including: (i) obtaining a training dataset, wherein the training dataset contains a plurality of sets of mathematical expressions, wherein each set of mathematical expressions of the plurality of sets of mathematical expressions includes two or more mathematically equivalent but not identical mathematical expressions; and (ii) using the training dataset, training an encoder and a decoder to generate, as an output of the decoder, an output mathematical expression that is mathematically equivalent to but not identical to an input mathematical expression that is applied as an input to the encoder, wherein the encoder generates, as an output that is provided as an input to the decoder, a continuous vector that is representative of the input mathematical expression.

EEE 6 is the method of EEE 5, wherein training the encoder and the decoder comprises: (i) parsing the input mathematical expression into an input ordered sequence of mathematical symbols; and (ii) applying each of the mathematical symbols of the input ordered sequence of mathematical symbols to a mapping function of the encoder to generate respective embedding vectors, thereby generating an ordered sequence of embedding vectors that represent the input ordered sequence of mathematical symbols in an embedding space.

EEE 7 is the method of EEE 6, wherein parsing the input mathematical expression into the input ordered sequence of mathematical symbols comprises generating the input ordered sequence of mathematical symbols to represent the input mathematical expression according to the reverse Polish notation.

EEE 8 is the method of any of EEEs 6-7, wherein the encoder further comprises an encoder recurrent network, wherein the encoder generating the continuous vector that is representative of the input mathematical expression comprises executing the encoder recurrent network a plurality of iterations, wherein executing the encoder recurrent network a given first iteration of the plurality of iterations comprises generating a first output hidden vector in the embedding space based on (i) a second output hidden vector generated from a prior execution of the encoder recurrent network and (ii) a first embedding vector of the ordered sequence of embedding vectors that corresponds to the first iteration, and wherein the continuous vector that is representative of the input mathematical expression is an output of the encoder recurrent network a final iteration of the plurality of iterations.

EEE 9 is the method of EEE 8, wherein executing the encoder recurrent network the first iteration to generate the first output hidden vector comprises: (i) generating an update vector based on (a) the second output hidden vector and (b) the first embedding vector; (ii) generating a proposed state vector based on (a) the second output hidden vector and (b) the first embedding vector; and (c) generating the first output hidden vector as a weighted combination of (a) the second output hidden vector and (b) the proposed state vector, wherein the weighting is performed according to the update vector.

EEE 10 is the method of any of EEEs 8-9, wherein the decoder receives as inputs all of the output hidden vectors generated from the encoder recurrent network.

EEE 1 is the method of any of EEEs 5-10, wherein the decoder comprises a decoder recurrent network, wherein the decoder generating the output mathematical expression comprises executing the decoder recurrent network a plurality of iterations to generate an output ordered sequence of mathematical symbols that represent the output mathematical expression, wherein executing the decoder recurrent network a given second iteration of the plurality of iterations comprises generating a first output symbol of the output ordered sequence of mathematical symbols based on a third output hidden vector, wherein executing the decoder recurrent network the second iteration further comprises generating the third output hidden vector based on (i) a fourth output hidden vector generated from a prior execution of the decoder recurrent network, (ii) a second embedding vector generated by applying, to a mapping function of the encoder, a second output symbol of the output ordered sequence of mathematical symbols generated by the prior execution of the decoder recurrent network, and (iii) the continuous vector.

EEE 12 is the method of EEE 11, wherein executing the decoder recurrent network the second iteration to generate the third output hidden vector comprises: (i) generating a context vector based on (a) the fourth output hidden vector and (b) the continuous vector; and (ii) generating the third output hidden vector based on a concatenation of the context vector and the second embedding vector.

EEE 13 is the method of EEE 12, wherein the encoder further comprises an encoder recurrent network, wherein the encoder generating the continuous vector that is representative of the input mathematical expression comprises executing the encoder recurrent network a plurality of iterations, wherein executing the encoder recurrent network a given third iteration of the plurality of iterations comprises generating a fifth output hidden vector in the embedding space based on a sixth output hidden vector generated from a prior execution of the encoder recurrent network, wherein the continuous vector that is representative of the input mathematical expression is an output of the encoder recurrent network a final iteration of the plurality of iterations, and wherein generating the context vector comprises generating the context vector based on (i) the fourth output hidden vector and (ii) all of the output hidden vectors generated from the encoder recurrent network.

EEE 14 is the method of any of EEEs 11-13, wherein generating the first output symbol on the third output hidden vector comprises applying a softmax function to a product of the third output hidden vector and a matrix to generate a probability vector representing the probability of the first output symbol across a set of possible output symbols.

EEE 15 is the method of EEE 14, wherein training the encoder and decoder comprises: (i) generating a loss function based on the probability vector; and (ii) training the encoder and decoder to increase the log-likelihood of the output ordered sequence of mathematical symbols, as determined based on the probability vector.

EEE 16 is the method of any of EEEs 5-15, wherein training the encoder and decoder comprises applying the teacher forcing algorithm.

EEE 17 is the method of any of EEEs 5-16, wherein the training dataset includes more than 4.5 million sets of mathematical expressions.

EEE 18 is the method of any of EEEs 5-17, wherein the continuous vector that is representative of the input mathematical expression has a dimensionality greater than 127.

EEE 19 is the method of any of EEEs 5-18, wherein obtaining the training dataset comprises using the method of any of EEEs 1-4 to generate at least one of the sets of mathematical expressions of the training dataset.

EEE 20 is a method including: (i) obtaining a target mathematical expression; and (ii) applying the target mathematical expression as an input to an encoder trained as in any of EEEs 5-19 to generate a target continuous vector that is representative of the target mathematical expression.

EEE 21 is the method of EEE 20, further comprising: (i) obtaining a plurality of continuous vectors that represent a plurality of additional mathematical expressions; and (ii) determining an output set of the additional mathematical expressions by determining a level of similarity between the target continuous vector and each of the plurality of continuous vectors and selecting those mathematical expressions of the plurality of additional mathematical expressions whose continuous vectors had a level of similarity to the target continuous vector that exceeded a threshold level of similarity.

EEE 22 is the method of EEE 20, further comprising: (i) obtaining a plurality of continuous vectors that represent a plurality of additional mathematical expressions; and (ii) determining an output set of the additional mathematical expressions by determining a level of similarity between the target continuous vector and each of the plurality of continuous vectors and selecting the top N mathematical expressions of the plurality of additional mathematical expressions with respect to the level of similarity of their continuous vectors to the target continuous vector.

EEE 23 is the method of any of EEEs 21-22, wherein obtaining the plurality of continuous vectors that represent the plurality of additional mathematical expressions comprises applying the plurality of additional mathematical expressions to the encoder to generate the plurality of continuous vectors.

EEE 24 is the method of any of EEEs 21-23, further comprising: providing an indication of the output set.

EEE 25 is the method of any of EEEs 21-24, further comprising: providing an indication of a set of citations to a set of references that contain mathematical expressions of the output set.

EEE 26 is a computer-implemented method including: (i) obtaining a target mathematical expression; and (ii) applying the target mathematical expression as an input to an encoder to generate a target continuous vector that is representative of the target mathematical expression, wherein the encoder comprises a mapping function and an encoder recurrent network, and wherein applying the target mathematical expression to the encoder to generate the target continuous vector includes: (a) parsing the target mathematical expression into an input ordered sequence of mathematical symbols; (b) applying each of the mathematical symbols of the input ordered sequence of mathematical symbols to the mapping function to generate respective embedding vectors, thereby generating an ordered sequence of embedding vectors that represent the input ordered sequence of mathematical symbols in an embedding space; and (c) executing the encoder recurrent network a plurality of iterations, wherein executing the encoder recurrent network a given first iteration of the plurality of iterations comprises generating a first output hidden vector in the embedding space based on (1) a second output hidden vector generated from a prior execution of the encoder recurrent network and (2) a first embedding vector of the ordered sequence of embedding vectors that corresponds to the first iteration, and wherein the continuous vector that is representative of the input mathematical expression is an output of the encoder recurrent network a final iteration of the plurality of iterations.

EEE 27 is the method of EEE 26, wherein parsing the input mathematical expression into the input ordered sequence of mathematical symbols comprises generating the input ordered sequence of mathematical symbols to represent the input mathematical expression according to the reverse Polish notation.

EEE 28 is the method of any of EEEs 26-27, wherein executing the encoder recurrent network the first iteration to generate the first output hidden vector includes: (i) generating an update vector based on (a) the second output hidden vector and (b) the first embedding vector; (ii) generating a proposed state vector based on (a) the second output hidden vector and (b) the first embedding vector; and (iii) generating the first output hidden vector as a weighted combination of (a) the second output hidden vector and (b) the proposed state vector, wherein the weighting is performed according to the update vector.

EEE 29 is the method of any of EEEs 26-28, wherein the continuous vector that is representative of the input mathematical expression has a dimensionality greater than 127.

EEE 30 is the method of any of EEEs 26-29, further comprising: (i) obtaining a plurality of continuous vectors that represent a plurality of additional mathematical expressions; and (ii) determining an output set of the additional mathematical expressions by determining a level of similarity between the target continuous vector and each of the plurality of continuous vectors and selecting those mathematical expressions of the plurality of additional mathematical expressions whose continuous vectors had a level of similarity to the target continuous vector that exceeded a threshold level of similarity.

EEE 31 is the method of any of EEES 26-29, further comprising: (i) obtaining a plurality of continuous vectors that represent a plurality of additional mathematical expressions; and (ii) determining an output set of the additional mathematical expressions by determining a level of similarity between the target continuous vector and each of the plurality of continuous vectors and selecting the top N mathematical expressions of the plurality of additional mathematical expressions with respect to the level of similarity of their continuous vectors to the target continuous vector.

EEE 32 is the method of any of EEEs 30-31, wherein obtaining the plurality of continuous vectors that represent the plurality of additional mathematical expressions comprises applying the plurality of additional mathematical expressions to the encoder to generate the plurality of continuous vectors.

EEE 33 is the method of any of EEEs 30-32, further comprising: providing an indication of the output set.

EEE 34 is the method of any of EEEs 30-33, further comprising: providing an indication of a set of citations to a set of references that contain mathematical expressions of the output set.

EEE 35 is the method of any of EEEs 26-34, wherein the encoder has been trained as in any of EEEs 5-19 to generate a target continuous vector that is representative of the target mathematical expression.

EEE 36 is a non-transitory computer-readable medium, having stored thereon program instructions that, upon execution by a computing device, cause the computing device to perform the method of any preceding EEE.

We claim:

1. A computer-implemented method comprising:
obtaining a training dataset, wherein the training dataset contains a plurality of sets of mathematical expressions, wherein each set of mathematical expressions of the plurality of sets of mathematical expressions includes two or more mathematically equivalent but not identical mathematical expressions; and
using the training dataset, training an encoder and a decoder to generate, as an output of the decoder, an output mathematical expression that is mathematically equivalent to but not identical to an input mathematical expression that is applied as an input to the encoder, wherein the encoder generates, as an output that is provided as an input to the decoder, a continuous vector that is representative of the input mathematical expression.

2. The method of claim 1, wherein training the encoder and the decoder comprises:
parsing the input mathematical expression into an input ordered sequence of mathematical symbols; and
applying each of the mathematical symbols of the input ordered sequence of mathematical symbols to a mapping function of the encoder to generate respective embedding vectors, thereby generating an ordered sequence of embedding vectors that represent the input ordered sequence of mathematical symbols in an embedding space.

3. The method of claim 2, wherein parsing the input mathematical expression into the input ordered sequence of mathematical symbols comprises generating the input ordered sequence of mathematical symbols to represent the input mathematical expression according to the reverse Polish notation.

4. The method of claim 2, wherein the encoder further comprises an encoder recurrent network, wherein the encoder generating the continuous vector that is representative of the input mathematical expression comprises executing the encoder recurrent network a plurality of iterations, wherein executing the encoder recurrent network a given first iteration of the plurality of iterations comprises generating a first output hidden vector in the embedding space based on (i) a second output hidden vector generated from a prior execution of the encoder recurrent network and (ii) a first embedding vector of the ordered sequence of embedding vectors that corresponds to the first iteration, and wherein the continuous vector that is representative of the input mathematical expression is an output of the encoder recurrent network a final iteration of the plurality of iterations.

5. The method of claim 4, wherein executing the encoder recurrent network the first iteration to generate the first output hidden vector comprises:
generating an update vector based on (i) the second output hidden vector and (ii) the first embedding vector;
generating a proposed state vector based on (i) the second output hidden vector and (ii) the first embedding vector; and
generating the first output hidden vector as a weighted combination of (i) the second output hidden vector and (ii) the proposed state vector, wherein the weighting is performed according to the update vector.

6. The method of claim 4, wherein the decoder receives as inputs all of the output hidden vectors generated from the encoder recurrent network.

7. The method of claim 1, wherein the decoder comprises a decoder recurrent network, wherein the decoder generating the output mathematical expression comprises executing the decoder recurrent network a plurality of iterations to generate an output ordered sequence of mathematical symbols that represent the output mathematical expression, wherein executing the decoder recurrent network a given second iteration of the plurality of iterations comprises generating a first output symbol of the output ordered sequence of mathematical symbols based on a third output hidden vector, wherein executing the decoder recurrent network the second iteration further comprises generating the third output hidden vector based on (i) a fourth output hidden vector generated from a prior execution of the decoder recurrent network, (ii) a second embedding vector generated by applying, to a mapping function of the encoder, a second output symbol of the output ordered sequence of mathematical symbols generated by the prior execution of the decoder recurrent network, and (iii) the continuous vector.

8. The method of claim 7, wherein executing the decoder recurrent network the second iteration to generate the third output hidden vector comprises:
generating a context vector based on (i) the fourth output hidden vector and (ii) the continuous vector; and
generating the third output hidden vector based on a concatenation of the context vector and the second embedding vector.

9. The method of claim 8, wherein the encoder further comprises an encoder recurrent network, wherein the encoder generating the continuous vector that is representative of the input mathematical expression comprises executing the encoder recurrent network a plurality of iterations, wherein executing the encoder recurrent network a given third iteration of the plurality of iterations comprises generating a fifth output hidden vector in the embedding space based on a sixth output hidden vector generated from a prior execution of the encoder recurrent network, wherein the continuous vector that is representative of the input mathematical expression is an output of the encoder recurrent network a final iteration of the plurality of iterations, and wherein generating the context vector comprises generating the context vector based on (i) the fourth output hidden vector and (ii) all of the output hidden vectors generated from the encoder recurrent network.

10. The method of claim 7, wherein generating the first output symbol on the third output hidden vector comprises applying a softmax function to a product of the third output hidden vector and a matrix to generate a probability vector representing the probability of the first output symbol across a set of possible output symbols.

11. The method of claim 10, wherein training the encoder and decoder comprises:
generating a loss function based on the probability vector; and
training the encoder and decoder to increase the log-likelihood of the output ordered sequence of mathematical symbols, as determined based on the probability vector.

12. The method of claim 1, wherein obtaining the training dataset comprises:
obtaining a representation of an input mathematical expression;
generating an initial e-graph representation of the input mathematical expression;
applying a set of mathematical rewrite rules to the initial e-graph a plurality of times to generate a saturated e-graph representation of the mathematical expression, wherein the saturated e-graph includes a root e-class that contains at least one e-node;
generating a mathematical grammar based on the saturated e-graph by, for each e-class of the saturated e-graph, generating a respective set of one or more replacement expressions, wherein a replacement expression of a given e-class corresponds to a respective e-node of the given e-class; and
generating a plurality of different output mathematical expressions that are equivalent to the input mathematical expression by, for strings representing each of the e-nodes in the root e-class, recursively applying the replacement expressions of the mathematical grammar to replace elements of the strings.

13. A method comprising:
obtaining a target mathematical expression; and
applying the target mathematical expression as an input to an encoder to generate a target continuous vector that is representative of the target mathematical expression, wherein the encoder has been trained by:
obtaining a training dataset, wherein the training dataset contains a plurality of sets of mathematical expressions, wherein each set of mathematical expressions of the plurality of sets of mathematical expressions includes two or more mathematically equivalent but not identical mathematical expressions; and
using the training dataset, training the encoder and a decoder to generate, as an output of the decoder, an output mathematical expression that is mathematically equivalent to but not identical to an input mathematical expression that is applied as an input to the encoder, wherein the encoder generates, as an output that is provided as an input to the decoder, a continuous vector that is representative of the input mathematical expression.

14. The method of claim 13, further comprising:
obtaining a plurality of continuous vectors that represent a plurality of additional mathematical expressions; and
determining an output set of the additional mathematical expressions by determining a level of similarity between the target continuous vector and each of the plurality of continuous vectors and selecting those mathematical expressions of the plurality of additional mathematical expressions whose continuous vectors had a level of similarity to the target continuous vector that exceeded a threshold level of similarity.

15. The method of claim 13, further comprising:
obtaining a plurality of continuous vectors that represent a plurality of additional mathematical expressions; and
determining an output set of the additional mathematical expressions by determining a level of similarity between the target continuous vector and each of the plurality of continuous vectors and selecting the top N mathematical expressions of the plurality of additional mathematical expressions with respect to the level of similarity of their continuous vectors to the target continuous vector.

16. The method of claim 21, wherein obtaining the plurality of continuous vectors that represent the plurality of additional mathematical expressions comprises applying the plurality of additional mathematical expressions to the encoder to generate the plurality of continuous vectors.

17. The method of claim 21, further comprising:
providing an indication of a set of citations to a set of references that contain mathematical expressions of the output set.

18. A computer-implemented method comprising:
obtaining a representation of an input mathematical expression;
generating an initial e-graph representation of the mathematical expression;
applying a set of mathematical rewrite rules to the initial e-graph a plurality of times to generate a saturated e-graph representation of the mathematical expression, wherein the saturated e-graph includes a root e-class that contains at least one e-node;
generating a mathematical grammar based on the saturated e-graph by, for each e-class of the saturated e-graph, generating a respective set of one or more replacement expressions, wherein a replacement expression of a given e-class corresponds to a respective e-node of the given e-class;
and generating a plurality of different output mathematical expressions that are equivalent to the input mathematical expression by, for strings representing each of the e-nodes in the root e-class, recursively applying the replacement expressions of the mathematical grammar to replace elements of the strings.

19. The computer-implemented method of claim 18, wherein recursively applying the replacement expressions of the mathematical grammar to replace elements of the strings includes terminating the recursion if the number of elements in the rewritten string exceeds a specified maximum number of elements.

20. The computer-implemented method of claim 18, wherein generating the saturated e-graph representation of the mathematical expression includes detecting whether a potential rewrite rule matches any rewrite rule of a specified set of non-desired expansions and, responsive to determining that the potential rewrite rule does not match any rewrite rule of the specified set, applying the potential mathematical rewrite rule to the initial e-graph.
